(19) United States
(12) Patent Application Publication
(10) Pub. No.: US 2011/0042856 A1
(43) Pub. Date: Feb. 24, 2011

(54) ELECTROPHOTOGRAPHIC INTERMEDIATE TRANSFER BELT AND METHOD FOR PRODUCING THE SAME, AND ELECTROPHOTOGRAPHIC APPARATUS

(75) Inventors: Jun AOTO, Kanagawa (JP); Hidetaka Kubo, Kanagawa (JP); Kenichi Mashiko, Kanagawa (JP)

Correspondence Address: COOPER & DUNHAM, LLP, 30 Rockefeller Plaza, 20th Floor, NEW YORK, NY, 10112, US

(73) Assignee: RICOH COMPANY, LTD., Tokyo (JP)

(21) Appl. No.: 12/854,983

(22) Filed: Aug. 12, 2010

(30) Foreign Application Priority Data
Aug. 20, 2009 (JP) 2009-190868

(51) Int. Cl. B29C 41/42; G03G 15/01

(52) U.S. Cl. 264/334; 399/302

(57) ABSTRACT

An electrophotographic intermediate transfer belt obtained by applying a coating liquid to any of an inner surface and an outer surface of the mold, and then drying or curing so as to form a film, and demolding the film, including a surface having a black density of 2.2 to 3, and the other surface having a black density which is different from that of the surface by 0.5 or less, wherein the black density is measured by a spectrodensitometer, and the other surface has been in contact with the mold and the surface having the black density of 2.2 to 3 has been exposed to air during the production of the intermediate transfer belt, and wherein the coating liquid comprises at least a carbon black, any of a resin and a resin precursor, and a solvent.

### BACKGROUND OF THE INVENTION

1. Field of the Invention

The present invention relates to an intermediate transfer belt which is mounted in electrophotographic apparatuses such as copiers, printers or the like, and is suitable for a full color image formation, a method for producing the intermediate transfer belt, and an electrophotographic apparatus using the intermediate transfer belt.

2. Description of the Related Art

Conventionally, in electrophotographic apparatuses (image forming apparatuses), seamless belts have been used as members for various applications. Particularly, in full color electrophotographic apparatuses of recent years, an intermediate transfer belt system is used, in which development images of four colors, yellow, magenta, cyan, black, are superimposed on an intermediate transfer medium, and then the superimposed images are collectively transferred to a transfer medium, such as paper.

In such intermediate transfer belt system, with respect to a photoconductor four developing units are used, but use of such intermediate transfer belt system has a disadvantage that print speed is slow.

For high speed printing, a four-series tandem system is used in which photoconductors for four colors are tandemly arranged, and each color is continuously transferred on paper. However, in this system, it is difficult to achieve accurate registration upon superimposing respective images because of change of paper condition due to environment, providing color drifted images. Thus, recently, an intermediate transfer system has been predominately applied in the four-series tandem system.

For this reason, characteristics required for the intermediate transfer belt have been tough to achieve, such as high speed transfer, positional accuracy, etc., but it is necessary to satisfy those characteristics. Particularly, it is demanded to inhibit variation in positional accuracy caused by deformation such as elongation of a belt itself due to continuous use. The intermediate transfer belt is required to be fire retardant, because it occupies a large area of an apparatus and a high voltage is applied thereto for transferring an image. In order to satisfy these demands, as an intermediate transfer belt material, a polyimide resin, and a polyamideimide resin, which have high elasticity and high heat resistance, are used.

In the intermediate transfer belt system, since a charged toner image is transferred by electric field action, it is necessary for an intermediate transfer belt to be adjusted to a preferable resistance value. As the resistance value, generally a surface resistance value is adjusted to approximately 1×10⁷ Ω/square to 1×10¹³ Ω/square, and a volume resistance value is adjusted to approximately 1×10⁵ Ω·cm to 1×10¹² Ω·cm. These resistance values are adjusted by dispersing organic or inorganic conductive particles or containing materials such as a conductive polymer or an ion conductive agent in a resin. Of these, carbon black is particularly preferably used.

In the case where a polyimide resin or a polyamideimide resin is used as a resin for forming an intermediate transfer belt, a polyimide resin or a polyamideimide resin, particularly carbon black is preferably used for adjusting the aforementioned resistance values. The polyimide resin or the polyamideimide resin is formed by thermally curing a resin solution, in which a polyimide resin precursor or a polyamideimide resin precursor is dissolved in a polar solvent. As the polar solvent to be used, N-methyl-2-pyrrolidone is preferably used, because it is preferably acts on dispersibility of the carbon black.

A carbon black is dispersed in the polyimide resin or the polyamideimide resin in such a manner that the carbon black is dispersed together with a polyimide resin precursor or a polyamideimide resin precursor in a solvent using a widely-used disperser, such as a bead mill, a ball mill, a paint shaker, or a planetary ball mill, so that the carbon black is dispersed in the state of fine particles having a desired particle size in the resin solution. Then, by using the resin solution in which the carbon black is dispersed, an intermediate transfer belt having a desired and uniform resistance value, are produced.

In order to obtain an intermediate transfer belt (or electrophotographic seamless belt) having preferable electric properties, the following proposals have been made.

For example, by surface treatment or by use of a dispersant, a method of attaining a suitable dispersion of carbon black (or resistance control agent, filler, etc.) in a polyimide resin is proposed (see Japanese Patent (JP-B) Nos. 4175513 and 4189915, Japanese Patent Application Laid-Open (JP-A) Nos. 2006-348094, 2006-58516, 2007-204531, and 2008-152055).

JP-A No. 2007-140055 discloses a method of obtaining a conductive seamless belt by defining a maximum particle size of coarse particles of a carbon black.

JP-A No. 2007-127825 proposes that a carbon black is sufficiently dispersed in a seamless belt by using a coating liquid formed of a solution containing at least two polyamideimide resins having different molecular mass.

Proposed is a method of improving affinity of a carbon black with polyimide or attaining uniform electric resistance by defining fluctuation of a volume average particle size of the carbon black in a coating liquid to be used (JP-A Nos. 2007-248786, 2008-9248).

JP-A No. 2004-123774 proposes a polyimide resin composition, in which a black density formed of a polyimide resin, a semiconductive filler, and a carbon black is defined, and a film and tubular matter formed using the polyimide resin composition, because in electrophotographic applications transfer belts, intermediate transfer belts or fixing belts are desired to have a small voltage dependency of resistance value and be in the color of black color for inhibiting light reflectance. The black density mentioned in JP-A No. 2004-123774 is aimed to inhibit light reflectance. As can be seen from Examples, the resistance value is not controlled by carbon black, and the resistance (for example, surface resistance) is not controlled by defining the black density. In Examples, the black density of the polyimide resin composition may be defined with respect to either an outer surface or inner surface of a metal mold. JP-A No. 2004-123774 does not described whether the inner surface or the outer surface is measured to define the black density.

Under the conditions, and process control defined in the above-described proposals, electric properties of the intermediate transfer belts can be improved to a certain degree. However, in order to reproducibly achieve the intermediate transfer belts, it is necessary to strictly control materials in the production. Namely, in the above proposals, due to difference among production lots or material lots such as those of a carbon black, a resin, or the like, the amount of the carbon black for obtaining a desired resistance value and the resistance value varies, which causes defective products, and makes the production unstable.

### BRIEF SUMMARY OF THE INVENTION

An object of the present invention is to provide an electrophotographic intermediate transfer belt having a suitable and highly uniform resistance value by adding a stable amount of carbon black, despite variation in production lots, material lots such as those of a carbon black, a resin and/or resin precursor used in a coating liquid, a method for producing the electrophotographic intermediate transfer belt, and an electrophotographic apparatus, in which the intermediate transfer belt is mounted.

The inventors of the present invention have intensively studied to solve the above-described problems, and achieved the following findings. In the case where an electrophotographic intermediate transfer belt is produced in such a manner that a coating liquid containing at least a carbon black, a resin and/or resin precursor, and a solvent is applied to an inner surface or an outer surface of a metal mold (for example, a rotatable cylindrical mold) to form a coating film, and the coating film is dried and/or cured to form a film, particularly in a drying and/or curing step, the dispersibility of the carbon black varies in a surface of the intermediate transfer belt which has been exposed to air during the production thereof and is easily adversely changed. Consequently, the black density of the surface being exposed to air during the production of the intermediate transfer belt is lower than that of a surface being in contact with the mold during the production thereof, causing variation in resistance value, and formation of abnormal images. These problems are solved by adjusting the black density of the surface of the intermediate transfer belt, which has been exposed to air during the production thereof to 2.2 to 3, and by adjusting the difference in the black density between the surface thereof being exposed to air and the other surface thereof (i.e. the other surface of the intermediate transfer belt) being in contact with the mold during the production thereof to 0.5 or less, in the case where the black density is measured with a spectrodensitometer.

A method for producing the electrophotographic intermediate transfer belt of the present invention, includes producing a carbon black dispersion liquid having high concentration of carbon black by using a solution containing at least a carbon black and a solvent, or a carbon black, resin and/or a resin precursor and solvent (dispersion liquid production step), mixing and stirring the dispersion liquid and a resin solution to prepare the amount of the carbon black to be added, so as to produce a coating liquid (coating liquid production step), wherein the black density of the carbon black dispersion liquid in the dispersion liquid production step is 2.2 or more. The method for producing the intermediate transfer belt of the present invention enables to obtain an intermediate transfer belt, which satisfies the following conditions that a surface having a black density of 2.2 to 3, and the other surface having a black density which is different from that of the surface by 0.5 or less, wherein the black density is measured by a spectrodensitometer, and the other surface has been in contact with the mold and the surface having the black density of 2.2 to 3 has been exposed to air during the production of the intermediate transfer belt. Here, the black density of the carbon black dispersion liquid is measured in such a manner that a carbon black dispersion liquid is applied to a substrate, and dried so as to form a coating film, and then the surface thereof is measured with a spectrodensitometer.

The present invention is based on the above-described findings of the present invention, and means for solving the problems is as follows.

<1> An electrophotographic intermediate transfer belt obtained by applying a coating liquid to any of an inner surface and an outer surface of the mold, and then drying or curing so as to form a film, and demolding the film, including a surface having a black density of 2.2 to 3, and the other surface having a black density which is different from that of the surface by 0.5 or less, wherein the black density is measured by a spectrodensitometer, and the other surface has been in contact with the mold and the surface having the black density of 2.2 to 3 has been exposed to air during the production of the intermediate transfer belt, and wherein the coating liquid contains at least a carbon black, any of a resin and a resin precursor, and a solvent.
<2> The electrophotographic intermediate transfer belt according to <1>, wherein the carbon black is a resistance control agent.
<3> The electrophotographic intermediate transfer belt according to <1>, wherein the amount of the carbon black in the intermediate transfer belt is 15% by mass to 25% by mass.
<4> The electrophotographic intermediate transfer belt according to <1>, wherein the mold is in the shape of cylinder.
<5> The electrophotographic intermediate transfer belt according to <1>, wherein the resin precursor is any of a polyimide resin precursor and a polyamideimide resin precursor, and the resin contained in the intermediate transfer belt is any of a polyimide resin and a polyamideimide resin.
<6> A method for producing an electrophotographic intermediate transfer belt, including dispersing a carbon black in a solvent, or dispersing a carbon black with any of a resin and a resin precursor in a solvent, so as to produce a carbon black dispersion liquid, mixing the carbon black dispersion liquid with at least any of a resin and a resin precursor, and a solvent, so as to produce a coating liquid, applying the coating liquid to an inner surface or an outer surface of a mold to form a coating film, drying or curing the coating film so as to form a film, and demolding the film, wherein a black density of the coating film of the carbon black dispersion liquid is 2.2 or more, which is measured in such a manner that the carbon black dispersion liquid is applied to a substrate to form a coating film and the coating film is measured with a spectrodensitometer, and wherein an electrophotographic intermediate transfer belt includes a surface having a black density of 2.2 to 3; and

the other surface having a black density which is different from that of the surface by 0.5 or less,

wherein the black density is measured by a spectrodensitometer, and the other surface has been in contact with the mold and the surface having the black density of 2.2 to 3 has been exposed to air during the production of the intermediate transfer belt.

<7> An electrophotographic apparatus including an electrophotographic intermediate transfer belt obtained by applying a coating liquid to any of an inner surface and an outer surface of the mold, and then drying or curing so as to form a film, and demolding the film, which includes a surface having a black density of 2.2 to 3, and the other surface having a black density which is different from that of the surface by 0.5 or less, wherein the black density is measured by a spectrodensitometer, and the other surface has been in contact with the mold and the surface having the black density of 2.2 to 3 has been exposed to air during the production of the intermediate transfer belt, and wherein the coating liquid contains at least a carbon black, any of a resin and a resin precursor, and a solvent.

According to the present invention, an intermediate transfer belt, which solves problems in the conventional art, and has the following effects, is used for an electrophotographic apparatus, and an electrophotographic apparatus using the intermediate transfer belt.

That is, in the electrophotographic intermediate transfer belt of the present invention, the black density of the surface of the intermediate transfer belt, which has been exposed to air during the production thereof (i.e. the surface of the intermediate transfer belt) is adjusted to 2.2 to 3, and the difference in the black density between the surface thereof being exposed to air and the other surface thereof (i.e. the other surface of the intermediate transfer belt) being in contact with the mold during the production thereof is adjusted to 0.5 or less, in the case where the black density is measured with a spectrodensitometer, so that the dispersion state of the carbon black is kept uniform, and that density decrease is prevented in the surface being exposed to air during the production of the intermediate transfer belt, and a suitable amount of the carbon black is added, so that the electrophotographic intermediate transfer belt has a suitable resistance value with less variation, and a high reliability of electrical properties. The electrophotographic intermediate transfer belt of the present invention can print high quality image with inhibiting formation of abnormal images even when images are repeatedly formed. Moreover, as a resin component, a polyimide resin or polyamideimide resin is used so as to form an intermediate transfer belt excellent in mechanical strength, durability, fire retardancy, and the like, and thus the intermediate transfer belt can satisfy strict demands for characteristics such as high speed, positional accuracy.

The method for producing an electrophotographic intermediate transfer belt of the present invention, enables to obtain a electrophotographic intermediate transfer belt having a suitable and highly uniform resistance value by adding a stable amount of carbon black, despite variation in production lots, material lots such as those of a carbon black, a resin and/or a resin precursor.

An electrophotographic apparatus of the present invention uses the electrophotographic intermediate transfer belt of the present invention having resistance value with less variation and a high reliability of electrical properties and high durability, even when images are repeatedly formed, uneven image density, unprinted image portion, white spots, etc. can be prevented, and high quality image can be continuously printed in a stable manner.

### BRIEF DESCRIPTION OF THE DRAWINGS

FIG. 1 is schematic diagram of a main section for explaining an example of an intermediate transfer belt used as a belt member of an electrophotographic apparatus of the present invention, and the electrophotographic apparatus using the intermediate transfer belt.

FIG. 2 is a schematic diagram of a main section showing an example of a structure of an electrophotographic apparatus, in which a plurality of photoconductor drums are tandemly arranged along an intermediate transfer belt provided as a belt member of the electrophotographic apparatus of the present invention.

FIG. 3 is a schematic view showing an example of a disperser of a pass system used for the production of a carbon black dispersion liquid in a dispersion liquid production step according to the present invention.

FIG. 4 is a schematic view showing an example of a disperser of a circulation system used for the production of the carbon black dispersion liquid in the dispersion liquid production step according to the present invention.

### DETAILED DESCRIPTION OF THE INVENTION

### Electrophotographic Intermediate Transfer Belt

An electrophotographic intermediate transfer belt (hereinafter, also referred to as an intermediate transfer belt) of the present invention is produced in such a manner that a coating liquid, which contains at least a carbon black, any of a resin and a resin precursor, and a solvent is applied to either an inner surface or an outer surface of a mold, so as to form a coating film, the coating film is dried or cured to form a film, and then the film is demolded to thereby produce a electrophotographic intermediate transfer belt.

The intermediate transfer belt has a surface having a black density of 2.2 to 3, and the other surface having a black density which is different from that of the surface by 0.5 or less, wherein the black density is measured by a spectrodensitometer, and the other surface has been in contact with the mold and the surface having the black density of 2.2 to 3 has been exposed to air during the production of the intermediate transfer belt. Here, the carbon black serves as a resistance control agent. The amount of the carbon black in the intermediate transfer belt is 15% by mass to 25% by mass.

Namely, the black density of the surface of the intermediate transfer belt, which has been exposed to air during the production thereof (i.e. the surface of the intermediate transfer belt) is adjusted to 2.2 to 3, and the difference in the black density between the surface thereof being exposed to air and the other surface thereof (i.e. the other surface of the intermediate transfer belt) being in contact with the mold during the production thereof is adjusted to 0.5 or less, to thereby inhibit adverse changes in the dispersion state of the carbon black of the surface being exposed to air. As a result, a proper amount of the carbon black is added to provide an intermediate transfer belt, which has high reliability, has suitable and highly uniform resistance value, and less variation in the resistance value, to thereby provide high quality image without forming abnormal images.

In the electrophotographic apparatus, belts are used for a several members. Of these, an intermediate transfer belt is one of important members, which is demanded for electrical properties. Hereinafter, the intermediate transfer belt of the present invention will be explained.

The intermediate transfer belt of the present invention contains at least a widely used resin, and a filler for adjusting electrical resistance (electrical resistance control agent (also referred to as a “resistance control agent”) (a carbon black).

Examples of the resin include fluorine resins such as PVDF, ETFE, polyimide resins (also referred to as “polyimide”) and polyamideimide resins (also referred to as “polyamideimide”), in terms of fire retardancy. Of these, polyimide and polyamideimide are particularly preferable, in terms of mechanical strength, or dispersibility of the resistance control agent.

The polyimide or the polyamideimide is used as a constituent of the intermediate transfer belt, so as to obtain excellent mechanical strength and durability, and to secure fire retardancy. Thus, the polyimide or the polyamideimide can satisfy strict demands for characteristics of the intermediate transfer belt, such as positional accuracy even when high speed transfer or repetitive use is performed using an electrophotographic apparatus.

Examples of the filler (resistance control agents) include organic or inorganic conductive fine particles such as metals, metal oxides, and carbon blacks; ion conductive agents; and conductive polymers. The carbon blacks are preferably used in terms of low cost and excellent productivity.

Examples of the carbon blacks include ketjen black, furnace black, acetylene black, thermal black, and gas black. From these, one compatible with a solvent or a resin to be used is selected and used. Alternatively, the carbon blacks which are properly surface treated, may be used.

In the present invention, the carbon black is used as a resistance control agent, and other resistance control agents mentioned above may be used in combination.

The carbon black is contained in the intermediate transfer belt in an adequate amount for providing the intermediate transfer belt with a surface resistance of 1×10⁸ Ω/square to 1×10¹³ Ω/square, and a volume resistance of 1×10⁶ Ω·cm to 1×10¹² Ω·cm, as the resistance value. In view of the mechanical strength of the intermediate transfer belt, a carbon black is preferably used in an amount sufficient for forming a film which is not fragile, and does not easily break.

The amount of the carbon black is preferably 10% by mass to 30% by mass, and more preferably 15% by mass to 25% by mass, based on the total solid content. When the amount is less than 10% by mass, uniformity of resistance value may not be easily obtained, or withstand voltage may decrease. On the other hand, when the amount is more than 30% by mass, the mechanical strength of the belt may decrease, and durability may be poor.

A polyimide resin (hereinafter, also referred to as “polyimide”) or a polyamideimide resin (hereinafter, also referred to as “polyamideimide”), which are suitably used for materials of the intermediate transfer belt, will be specifically described.

### <Polyimide>

The polyimide is not particularly limited and can be appropriately selected depending on the intended purpose. For example, aromatic polyimide is preferable. The aromatic polyimide is obtained from polyamic acid (polyimide precursor), which is an intermediate product obtained by reacting a generally known aromatic polycarboxylic anhydride (or derivatives thereof) with aromatic diamine.

Because of stiff main chain, the polyimide, particularly, aromatic polyimide is insoluble in a solvent and is not melted. Therefore, at first, aromatic polycarboxylic anhydride is reacted with aromatic diamine so as to synthesize a polyimide precursor (i.e., a polyamic acid or polyamide acid) which is soluble in an organic solvent. The thus prepared polyamic acid is molded, followed by dehydration/cyclization treatment (i.e., imidization) upon application of heat thereto or using a chemical method, so as to form polyimide. The outline of the reaction is represented by Reaction Formula (1), which is an example of obtaining an aromatic polyimide.

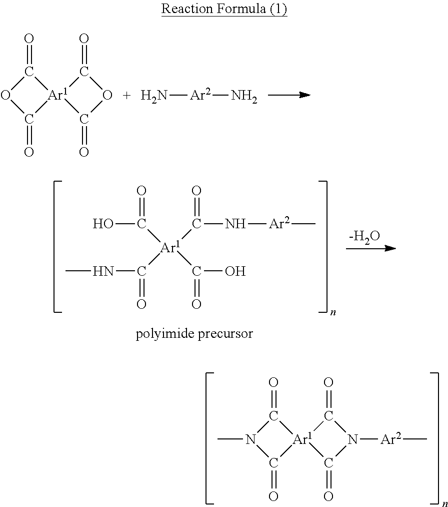

In Reaction Formula (1), Ar¹ denotes a tetravalent aromatic residue containing at least one six-membered carbon ring; and Are denotes a divalent aromatic residue containing at least one six-membered carbon ring.

Specific examples of tetravalent aromatic carboxylic anhydrides containing at least one six-membered carbon ring (aromatic polycarboxylic anhydrides) include pyromellitic dianhydride, 3,3′,4,4′-benzophenonetetracarboxylic dianhydride, 2,2′, 3,3′-benzophenonetetracarboxylic dianhydride, 3,3′,4,4′-biphenyltetracarboxylic dianhydride, 2,2′,3,3′-biphenyltetracarboxylic dianhydride, 2,2-bis(2,3-dicarboxyphenyl)propane dianhydride, bis(3,4-dicarboxyphenyl)ether dianhydride, bis(3,4-dicarboxyphenyl)sulfone dianhydride, 1,1-bis(2,3-dicarboxyphenyl)ethane dianhydride, bis(2,3-dicarboxyphenyl)methane dianhydride, bis(3,4-dicarboxyphenyl)methane dianhydride, 2,2-bis(3,4-dicarboxyphenyl)-1,1,1,3,3,3-hexafluoropropane dianhydride, 2,3,6,7-naphthalenetetracarboxylic dianhydride, 1,4,5,8-naphthalenetetracarboxylic dianhydride, 1,2,5,6-naphthalenetetracarboxylic dianhydride, 1,2,3,4-benzenetetracarboxylic acid dianhydride, 3,4,9,10-perylenetetracarboxylic dianhydride, 2,3,6,7-anthracenetetracarboxylic dianhydride, and 1,2,7,8-phenanthrenetetracarboxylic dianhydride. These may be used alone or in combination.

Examples of anhydrides other than the aromatic polycarboxylic anhydrides represented by Reaction Formula (1) include aliphatic or alicyclic polycarboxylic anhydrides, such as ethylenetetracarboxylic dianhydride, and cyclopentanetetracarboxylic dianhydride. These may be used alone or in combination with the aromatic polycarboxylic anhydrides.

In Reaction Formula (1), the aromatic polycarboxylic anhydride is exemplified, but the derivatives thereof (for example, ester derivatives) may be used.

Next, examples of divalent aromatic diamines containing at least one six-membered carbon ring (aromatic diamines), which is reacted with the aromatic polycarboxylic anhydrides, include m-phenylenediamine, o-phenylenediamine, p-phenylenediamine, m-aminobenzylamine, p-aminobenzylamine, 4,4′-diaminodiphenyl ether, 3,3′-diaminodiphenyl ether, 3,4′-diaminodiphenyl ether, bis(3-aminophenyl)sulfide, (3-aminophenyl)(4-aminophenyl)sulfide, bis(4-aminophenyl)sulfide, bis(3-aminophenyl)sulfoxide, (3-aminophenyl)(4-aminophenyl)sulfoxide, bis(3-aminophenyl)sulfone, (3-aminophenyl)(4-aminophenyl) sulfone, bis(4-aminophenyl) sulfone, 3,3′-diaminobenzophenone, 3,4′-diaminobenzophenone, 4,4′-diaminobenzophenone, 3,3′-diaminodiphenylmethane, 3,4′-diaminodiphenylmethane, 4,4′-diaminodiphenylmethane, bis[4-(3-aminophenoxy)phenyl]methane, bis[4-(4-aminophenoxy)phenyl]methane, 1,1-bis[4-(3-aminophenoxy)phenyl]ethane, 1,1-bis[4-(4-aminophenoxy)phenyl]ethane, 1,2-bis[4-(3-aminophenoxy)phenyl]ethane, 1,2-bis[4-(4-aminophenoxy)phenyl]ethane, 2,2-bis[4-(3-aminophenoxy)phenyl]propane, 2,2-bis[4-(4-aminophenoxy)phenyl]propane, 2,2-bis[4-(3-aminophenoxy)phenyl]butane, 2,2-bis[3-(3-aminophenoxy)phenyl]1,1,1,3,3,3-hexafluoropropane, 2,2-bis[4-(4-aminophenoxy)phenyl]1,1,1,3,3,3-hexafluoropropane, 1,3-bis(3-aminophenoxy)benzene, 1,3-bis(4-aminophenoxy)benzene, 1,4-bis(3-aminophenoxy)benzene, 1,4-bis(4-aminophenoxy)benzene, 4,4′-bis(3-aminophenoxy)biphenyl, 4,4′-bis(4-aminophenoxy)biphenyl, bis[4-(3-aminophenoxy)phenyl]ketone, bis[4-(4-aminophenoxy)phenyl]ketone, bis[4,(3-aminophenoxy)phenyl]sulfide, bis[4,(4-aminophenoxy)phenyl]sulfide, bis[4-(3-aminophenoxy)phenyl]sulfoxide, bis[4-(4-aminophenoxy)phenyl]sulfoxide, bis[4-(3-aminophenoxy)phenyl]sulfone, bis[4-(4-aminophenoxy)phenyl]sulfone, bis[4-(3-aminophenoxy)phenyl]ether, bis[4-(4-aminophenoxy)phenyl]ether, 1,4-bis[4-(3-aminophenoxy)benzoyl]benzene, 1,3-bis[4-(3-aminophenoxy)benzoyl]benzene, 4,4′-bis[3-(4-aminophenoxy)benzoyl]diphenyl ether, 4,4′-bis[3-(3-aminophenoxy)benzoyl]diphenyl ether, 4,4′-bis[4-(4-amino-α,α-dimethylbenzyl)phenoxy]benzophenone, 4,4′-bis[4-(4-amino-α,α-dimethylbenzyl)phenoxy]diphenyl sulfone, bis[4-{4-(4-aminophenoxy)phenoxy}phenyl]sulfone, 1,4-bis[4-(4-aminophenoxy)phenoxy]-α,α-dimethylbenzyl]benzene, and 1,3-bis[4-(4-aminophenoxy)-α,α-dimethylbenzyl]benzene. These may be used alone or in combination. Of these, 4,4′-diaminodiphenyl ether is particularly preferably used as at least one of the components for use in order to effectively exhibit the physical properties of the electrophotographic intermediate transfer belt of the present invention.

Meanwhile, aliphatic diamines other than the aromatic diamines represented by Reactive Formula (1) can be used, and may be used in combination with the aromatic diamines.

The aromatic polyimide is obtained in such a manner that a component of the aromatic polycarboxylic anhydride and a component of aromatic diamine are used approximately in an equimolar ratio, and subjected to polymerization reaction in an organic polar solvent so as to obtain a polyimide precursor (polyamic acid), and the polyamic acid is dehydrated, so as to cause cyclization and imidization. A method for producing a polyamic acid will be specifically described herein below.

Examples of the organic polar solvent, which is used in the polymerization reaction for obtaining polyamic acid, include sulfoxide solvents such as dimethylsulfoxide and diethylsulfoxide, formamide solvents such as N,N-dimethylformamide and N,N-diethylformamide, acetamide solvents such as N,N-dimethylacetamide and N,N-diethylacetamide, pyrrolidone solvents such as N-methyl-2-pyrrolidone and N-vinyl-2-pyrrolidone; phenol solvents such as phenol, o-, m- or p-cresol, xylenol, halogenated phenol, catechol; ether solvents such as tetrahydrofuran, dioxane, dioxolan; alcohol solvents such as methanol, ethanol, butanol; cellosolve solvents such as butyl cellosolve; and hexamethylphosphoramide, γ-butyrolactone. These may be used alone or in combination.

The solvent is not particularly limited and can be appropriately selected depending on the intended purpose, as long as the solvent can solve the polyamic acid. For example, N,N-dimethylacetamide, and N-methyl-2-pyrrolidone can be used.

One example of a method for preparing a polyimide precursor is as follows. At first, in an inert gas (such as argon gas and nitrogen gas) environment, one or more diamines are dissolved in an organic solvent, or may be dispersed in an organic solvent to form a slurry. When one or more aromatic polycarboxylic anhydrides or derivatives thereof are added in the resultant solution, in a form of solid, solution (in which the aromatic polycarboxylic anhydrides or derivatives thereof are dissolved in the organic solvent) or a slurry, a ring opening polymerization reaction accompanied with generation of heat is induced. In this case, the viscosity of the mixture rapidly increases, and a solution of polyamic acid having a high molecular mass is produced. In this case, the reaction temperature is preferably −20° C. to 100° C., and more preferably 60° C. or lower. The reaction time is preferably approximately 30 minutes to approximately 12 hours.

The addition order as described-above is one example, and is not limited thereto. Alternatively, firstly, aromatic polycarboxylic anhydride (aromatic tetracarboxylic dianhydrides) or derivative thereof is dissolved or dispersed in an organic solvent, and then the aromatic diamine (also referred to as “diamines”) may be added in the solution. The diamine may be added in a form of solid, solution (in which diamines are dissolved in the organic solvent) or slurry. That is, the addition order of an aromatic tetracarboxylic dianhydride component and a diamine component is not limited. In addition, the aromatic tetracarboxylic dianhydride and the aromatic diamine may be added at the same time to a polar organic solvent, so as to cause reaction.

As described above, the aromatic polycarboxylic anhydride or derivative thereof and the aromatic diamine component in an approximately equimolar ratio are polymerized in an organic polar solvent, so that a solution of a polyimide precursor in which the polyamic acid is uniformly dissolved in the polar organic solvent can be prepared.

As a polyimide precursor solution (i.e., a polyamic acid solution, “coating liquid containing polyimide resin precursor”) used in the present invention, the polyimide precursor solution synthesized as described-above can be used. Alternatively, as a convenient way, commercially available polyamic acid composition dissolved in an organic solvent, or polyimide varnishes may be used.

Specific examples of the commercially available polyimide varnishes include TORENEES (manufactured by Toray Industries INC.), U-VARNISH (manufactured by Ube Industries, Ltd.), RIKA COAT (manufactured by New Japan Chemical Co., Ltd.), OPTOMER (manufactured by JSR Corporation), SE812 (manufactured by Nissan Chemical Industries, Ltd.), and CRC8000 (manufactured by Sumitomo Bakelite Co., Ltd.).

The thus synthesized or commercially available polyamic acid solution may be optionally mixed and dispersed with a filler (for example, additives such as an electrical resistance control agent, dispersing agent, reinforcing agent, lubricant, heat conduction agent, antioxidant) to prepare a coating liquid.

The coating liquid is applied to a support (or a mold) as described below, and the coated liquid is then subjected to a treatment such as heating. Thus, the polyamic acid (i.e., a polyimide precursor) is transformed into polyimide (i.e., imidization).

The above-mentioned imidization reaction (i.e., conversion of a polyamic acid to a polyamide) is performed by (1) a heating method as described above or (2) a chemical method.

In (1) the heating method, the polyamic acid is heated at a temperature of 200° C. to 350° C. to be transformed into polyimide. The heating method is a simple and useful method of obtaining polyimide (a polyimide resin). In (2) the chemical method, the polyamic acid is reacted with a dehydration ring forming agent such as mixtures of a carboxylic anhydride and tertiary amine, and then the reaction product is heated to complete imidization. Thus, (2) the chemical method is complicated compared to (1) the heating method and therefore the manufacturing costs are relatively high. Accordingly, (1) the heating method is popularly used.

In general, it is preferred that polyamic acid or the reaction product thereof be completely imidized by heating at a temperature higher than the glass transition temperature of a resultant polyimide, so as to exhibit the polyimide intrinsic properties.

The imidization ratio (i.e., the degree of a polyamic acid transformed into a polyimide) can be determined by any known methods which are used for measuring the imidization ratio.

Examples thereof include a nuclear magnetic resonance (NMR) method in which the imidization ratio is determined on the basis of an integral ratio of ¹H of the amide group observed at 9 ppm to 11 ppm to ¹H of the aromatic group observed at 6 ppm to 9 ppm; a Fourier transfer infrared spectrophotometric method (i.e., FT-IR method); a method in which water generated by forming an imide ring is determined; and a method in which the amount of residual carboxylic acid is determined by a neutralization titration method. Of these methods, the FT-IR method is most commonly used.

When the FT-IR method is used, the imidization ratio is determined by the following equation (a).

Imidization ratio(%)=[(A)/(B)]×100 (a)

In the equation above, (A) represents the number of moles of the imide groups determined in the heating step (i.e., imidization step); and (B) represents the number of moles of the imide groups, when the polyamic acid is completely imidized (theoretically calculated).

The number of moles of the imide groups in this definition can be determined by the absorbance ratio of the characteristic absorption of the imide group, measured by the FT-IR method. For example, as a typical characteristic absorption, the imidization ratio can be evaluated using the following absorbance ratio:

(1) A ratio of the absorbance of a peak at 725 cm⁻¹, which is specific to the imide, and caused by the bending vibration of the C═O group of the imide ring, to the absorbance of a peak at 1,015 cm⁻¹ which is specific to the benzene ring;

(2) A ratio of the absorbance of a peak at 1,380 cm⁻¹, which is specific to the imide, and caused by the bending vibration of the C—N group of the imide ring, to the absorbance of a peak at 1,500 cm⁻¹ which is specific to the benzene ring;

(3) A ratio of the absorbance of a peak at 1,720 cm⁻¹, which is specific to the imide, and caused by the bending vibration of the C═O group of the imide ring, to the absorbance of a peak at 1,500 cm⁻¹ which is specific to the benzene ring; and

(4) A ratio of the absorbance of a peak at 1,720 cm⁻¹ (which is specific to the imide, and caused by the bending vibration of the C═O group of the imide ring) to the absorbance of a peak at 1,670 cm⁻¹ (which is specific to the amide group, and caused by the interaction of the bending vibration of the N—H group and the stretching vibration of the C—N group of the amide group).

In addition, when it is confirmed that the multiple absorption bands at 3,000 cm⁻¹ to 3,300 cm⁻¹, which are specific to the amide group, disappear, the reliability of completion of the imidization reaction is further enhanced.

### <Polyamideimide>

Polyamideimide has both an imide group which is rigid and an amide group which can impart flexibility to a resin in molecular skeleton thereof. Polyamideimide having known structures can be used in the present invention. The polyamideimide is not particularly limited, and can be appropriately selected depending on the intended purpose. Aromatic polyamideimides are particularly preferably used.

The polyamideimide is typically prepared by (a) an acid chloride method, (b) an isocyanate method, or the like.

(a) The acid chloride method in which a polyamideimide is obtained from polyamide-amic acid (polyamideimide resin precursor), which is an intermediate product obtained by reacting a derivative of a trivalent carboxylic acid compound having an acid anhydride group and a carbonyl halide group (hereinafter also referred to as “a derivative halide of a trivalent carboxylic acid compound having an acid anhydride group”) (e.g., typically, an acid chloride compound of the derivative) with diamine in a solvent (disclosed in, for example, Japanese patent application publication (JP-B) No. 42-15637).

(b) The isocyanate method in which a polyamideimide is produced by reacting a trivalent carboxylic acid compound having an acid anhydride group and a carboxylato group (hereinafter, also referred to a as “a derivative of a trivalent carboxylic acid having an acid anhydride group”) with an isocyanate compound (particularly preferably an aromatic isocyanate compound) in a solvent (disclosed in, for example, Japanese patent application publication (JP-B) No. 44-19274).

In the present invention, either (a) the acid chloride method or (b) the isocyanate method may be used. Each production method will be described with an example of aromatic polyamideimides, which is preferably used, as follows.

### (a) Acid Chloride Method

As the derivative halide of a trivalent carboxylic acid compound having an acid anhydride group, compounds represented by General Formula (2) or (3) can be used.

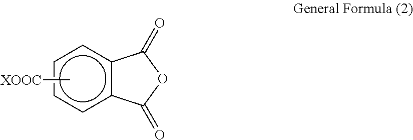

In General Formula (2), X represents a halogen atom.

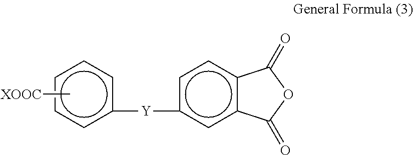

In General Formula (3), X represents a halogen atom, Y represents a single bond, —CH₂—, —CO—, —SO₂— or O—.

Examples of the halogen atom in General Formula (2) or (3) include a fluorine atom, a chlorine atom, and a bromine atom. The chlorine atom is preferably used. Typically, trimellitic anhydride chloride is used.

The derivative halide of the trivalent carboxylic acid compound having an acid anhydride group represented by General Formula (2) or (3) is an example of raw materials for obtaining the aromatic polyamideimides. The derivative halides of the trivalent carboxylic acid compound having an acid anhydride group is not limited thereto.

Other than the aromatic trivalent carboxylic acid compounds represented by General Formula (2) or (3), derivative halides of aliphatic trivalent carboxylic acid compound having an acid anhydride group can be used, and may be used in combination with aromatic derivatives.

On the other hand, in the acid chloride method, the diamines to be reacted with the aromatic polycarboxylic anhydrides are not particularly limited and can be appropriately selected depending on the intended purpose. Examples thereof include aromatic diamines, aliphatic diamines, and alicyclic diamines. Of these, aromatic diamines are preferably used.

Examples of the aromatic diamines include m-phenylenediamine, p-phenylenediamine, oxydianiline, diamino-m-xylylene, diamino-p-xylylene, 1,4-napthalenediamine, 1,5-napthalenediamine, 2,6-napthalenediamine, 2,7-napthalenediamine, 2,2′-bis-(4-aminophenyl)propane, 2,2′-bis-(4-aminophenyl)hexafluoropropane, 4,4′-diaminodiphenyl sulfone, 4,4′-diaminodiphenyl ether, 3,3′-diaminodiphenyl sulfone, 3,3′-diaminodiphenyl ether, 3,4-diaminobiphenyl, 4,4′-diaminobenzophenone, 3,4-diaminodiphenyl ether, isopropylidenedianiline, 3,3′-diaminobenzophenone, o-tolidine, 2,4-tolylenediamine, 1,3-bis-(3-aminophenoxy)benzene, 1,4-bis-(4-aminophenoxy)benzene, 1,3-bis-(4-aminophenoxy)benzene, 2,2-bis-[4-(4-aminophenoxy)phenyl]propane, bis-[4-(4-aminophenoxy)phenyl]sulfone, bis-[4-(3-aminophenoxy)phenyl]sulfone, 4,4′-bis-(4-aminophenoxy)biphenyl, 2,2′-bis-[4-(4-aminophenoxy)phenyl]hexafluoropropane, 4,4′-diaminodiphenyl sulfide, and 3,3′-diaminodiphenyl sulfide.

Examples of the aliphatic diamines include methylene diamine, and hexafluoroisopropylidene diamine.

By using a siloxane compound having an amino group at both ends thereof as diamine, a silicone-modified polyamideimide resin can be prepared. Examples of the siloxane compound include 1,3-bis(3-aminopropyl)-1,1,3,3-tetramethyldisiloxane, α,ω-bis(3-aminopropyl)-polydimethylsiloxane, 1,3-bis(3-aminophenoxymethyl)-1,1,3,3-tetramethyldisiloxane, α,ω-bis(3-aminophenoxymethyl)polydimethylsiloxane, 1,3-bis(2-(3-aminophenoxy)ethyl)-1,1,3,3-tetramethyldisiloxane, α,ω-bis(2-(3-aminophenoxy)ethyl)polydimethylsiloxane, 1,3-bis(3-(3-aminophenoxy)propyl)-1,1,3,3-tetramethyldisiloxane, and α,ω-bis(3-(3-aminophenoxy)propyl)polydimethylsiloxane.

In order to obtain polyamideimide (polyamideimide resin) in the present invention by the acid chloride method, in the same manner as in the production of the polyimide resin, the derivative halide of the trivalent carboxylic acid compound having an acid anhydride group and the diamine are dissolved in an organic polar solvent, and then reacted at a low temperature (0° C. to 30° C.) to form a polyamideimide resin precursor (polyamide-amic acid), and then the polyamideimide resin precursor is transformed into polyamideimide (i.e., imidization).

The organic polar solvent is not particularly limited as long as it solves polyamic acid, and the same organic polar solvents as those used in the polyimide can be used. Examples thereof include sulfoxide solvents (e.g., dimethyl sulfoxide, diethyl sulfoxide), formamide solvents (e.g., N,N-dimethyl formamide, N,N-diethyl formamide), acetamide solvents (e.g., N,N-dimethyl acetamide, N,N-diethyl acetamide), pyrrolidone solvents (e.g., N-methyl-2-pyrrolidone, N-vinyl-2-pyrrolidone), phenol solvents (e.g., phenol, o-, m-, or p-cresol, xylenol, phenol halide, catechol), ether solvents (e.g., tetrahydrofuran, dioxane, dioxolan), alcohol solvents (e.g., methanol, ethanol, butanol), cellosolve solvents (e.g., butyl cellosolve), and hexamethylphosphoramide, and γ-butyrolactone. These may be used alone or in combination. Of these, N,N-dimethyl acetamide, and N-methyl-2-pyrrolidone are particularly preferable.

The thus obtained polyamide/polyamic acid (polyamide-amic acid) solution is applied to a support (or a mold), and the coated liquid is then subjected to a treatment such as heating. Thus, the polyamide-amic acid is transformed into polyamideimide (polyamideimide) (i.e., imidization).

Examples of the imidization include a method of inducing dehydration ring-closing reaction by heating in the same manner as in the polyimide, and a method of chemically ring closing using a dehydrating/ring-closing catalyst.

When the dehydration ring-closing reaction is performed by heating, the reaction temperature is preferably 150° C. to 400° C., and more preferably 180° C. to 350° C. The heat treatment time is preferably 30 seconds to 10 hours, and more preferably 5 minutes to 5 hours. When the dehydrating/ring-closing catalyst is used, the reaction temperature is preferably 0° C. to 180° C., more preferably 10° C. to 80° C. The reaction time is preferably several tens minutes to several days, more preferably 2 hours to 12 hours.

Examples of the dehydrating/ring-closing catalyst include acid anhydrides such as acetic acid, propanoic acid, butyric acid, and benzoic acid.

### (b) Isocyanate Method

Examples of the trivalent carboxylic acid compound having an acid anhydride group and a carboxylato group (derivative of the trivalent carboxylic acid compound having an acid anhydride group) in the isocyanate method include compounds represented by General Formula (4) or (5).

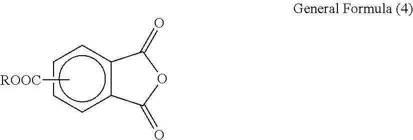

In General Formula (4), R denotes a hydrogen atom, an alkyl or phenyl group having 1 to 10 carbon atoms.

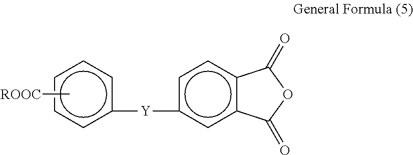

In General Formula (5), R denotes a hydrogen atom, an alkyl or phenyl group having 1 to 10 carbon atoms; Y denotes a single bond, —CH₂—, —CO—, —SO₂— or O—.

Any derivatives represented by General Formula (4) or (5) can be used, and trimellitic anhydride is typically used. The derivatives of the trivalent carboxylic acid compound having an acid anhydride group may be used alone or in combination depending on the intended purpose.

The derivative of the trivalent carboxylic acid compound having an acid anhydride group and a carboxylato group represented by General Formula (4) or (5) is an example of raw materials for obtaining aromatic polyamideimides. The derivative of the trivalent carboxylic acid compound having an acid anhydride group and a carboxylato group is not limited thereto.

Other than the aromatic trivalent carboxylic acid compounds represented by General Formula (4) or (5), aliphatic trivalent carboxylic acid compounds can be used. For example, the aliphatic trivalent carboxylic acid compounds can be used in combination of the aromatic carboxylic acid compounds.

Next, in the isocyanate method used for synthesizing the polyamideimide according to the present invention, the trivalent carboxylic acid compound having an acid anhydride group and a carboxylato group reacts with an isocyanate compound. Examples of the isocyanate compound include 4,4′-diphenylmethane diisocyanate, tolylene diisocyanate, xylene diisocyanate, 4,4′-diphenyl ether diisocyanate, 4,4′-[2,2-bis(4-phenoxyphenyl)propane]diisocyanate, biphenyl-4,4′-diisocyanate, biphenyl-3,3′-diisocyanate, biphenyl-3,4′-diisocyanate, 3,3′-dimethylbiphenyl-4,4′-diisocyanate, 2,2′-dimethylbiphenyl-4,4′-diisocyanate, 3,3′-diethylbiphenyl-4,4′-diisocyanate, 2,2′-diethylbiphenyl-4,4′-diisocyanate, 3,3′-dimethoxybiphenyl-4,4′-diisocyanate, 2,2′-dimethoxybiphenyl-4,4′-diisocyanate, naphthalene-1,5-diisocyanate, and naphthalene-2,6-diisocyanate.

As the isocyanate compound, an aromatic isocyanate compound (aromatic polyisocyanate) is particularly used. These aromatic polyisocyanates is used alone or in combination. Moreover, as necessary, aliphatic, alicyclic isocyanates, such as hexamethylene diisocyanate, 2,2,4-trimethylhexamethylene diisocyanate, isophorone diisocyanate, 4,4′-dicyclohexylmethane diisocyanate, transcyclohexane-1,4-diisocyanate, hydrogenated m-xylene diisocyanate, and lysine diisocyanate, and trivalent or higher functional polyisocyanates can be used.

In order to obtain polyamideimide used in the present invention by the isocyanate method, in the same manner as in the production of the polyimide, a solution containing a polyamideimide precursor prepared by dissolving the derivative of the trivalent carboxylic acid compound having an acid anhydride group and the aromatic polyisocyanate in an organic polar solvent is applied to a support (or a mold), and then the coated liquid is heated, so as to transform the polyamideimide precursor into polyamideimide. When the polyamideimide precursor is transformed into polyamideimide by the isocyanate method, carbon dioxide is generated to form polyamideimide without forming an intermediate product such as polyamic acid.

Reaction Formula (6) represents an example of formation of aromatic polyamideimide (polyamide imidization) by using trimellitic anhydride and aromatic diisocyanate.

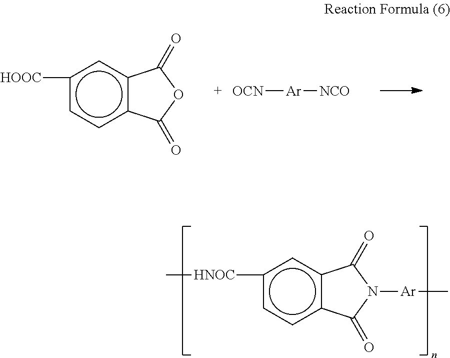

In Reaction Formula (6), Ar denotes a divalent aromatic group.

As the precursor transformed into polyimide and polyamideimide, a precursor obtained by reacting a single component used as a raw material is usually used. If necessary, a precursor obtained by reacting other components as raw materials selected from the standpoint of compatibility can be used in combination with the precursor obtained by reacting a single component. Moreover, copolymers having a polyimide repeat unit and a polyamideimide repeat unit may be used as the precursor.

As described above, the intermediate transfer belt, in which the black density of the surface thereof, which has been exposed to air during the production thereof is 2.2 to 3, and a difference in the black density between the surface thereof being exposed to air and the other surface thereof being in contact with the mold during the production thereof is 0.5 or less, is produced by a method for producing the intermediate transfer belt, including dispersing a carbon black in a solvent, or dispersing a carbon black with any of a resin and a resin precursor in a solvent, so as to produce a carbon black dispersion liquid (carbon black dispersion liquid production step); mixing the thus obtained carbon black dispersion liquid with at least any of a resin and a resin precursor, and a solvent, so as to produce a coating liquid (coating liquid production step); applying the coating liquid to an inner surface or an outer surface of a mold for a seamless belt to form a coating film, drying and/or curing the coating film so as to form a film, and demolding the film so as to produce a belt (belt production step).

Therefore, the present invention provides an electrophotographic intermediate transfer belt, which has a suitable and highly uniform resistance value, and high durability by adding a stable amount of carbon black, despite variation in production lots, material lots such as those of a carbon black, a resin and/or a resin precursor, and can provide high quality images.

For example, examples of a method for producing an intermediate transfer belt (hereinafter, also referred to as a “seamless belt”) using the coating liquid containing the polyimide precursor or the polyamideimide precursor, includes a method for forming a film by applying the coating liquid to an inner surface of a mold, for example, a cylindrical metal mold, and a method for forming a film by applying the coating liquid to an outer surface of the metal mold. In the present invention, any of the methods can be used without limitation. Hereinafter, the method for forming a film will be described.

Hereinafter, a centrifugal casting as a method for forming a film on an inner surface of a mold will be described.

The description below is an embodiment, and the conditions etc. are not limited thereto.

In centrifugal casting, a metal mold which is a cylindrical rotating body is slowly rotated so as to uniformly apply and flow-cast a coating liquid onto an entire inner surface thereof (formation of a coating film). Thereafter, rotational speed is increased to a predetermined speed, and a rotation is continued for a desired time period, while the predetermined speed is maintained at a constant rate. Then, the temperature is gradually raised while rotating the metal mold, and a solvent in the coating film is evaporated at approximately 80° C. to approximately 150° C. In this process, it is preferred that the vapor in atmosphere (evaporated solvent, etc.) be efficiently circulated and removed. When a film having self-support ability is obtained, the mold is cooled to room temperature. The mold is placed in a furnace (baking furnace) which can perform a high temperature treatment, and is gradually heated, and is finally treated (baked) at high temperature of approximately 250° C. to approximately 450° C., so as to sufficiently transform a polyimide precursor into polyimide (i.e., imidization) or a polyamideimide precursor into polyamideimide (i.e., polyamide imidization). After the imidization has been completed, the mold was gradually cooled, and a formed film is separated from the mold (demolded), to thereby produce a seamless belt. It is preferred that a releasing agent be applied to or a release layer be formed preliminarily on the mold, so as to easily separate the film from the mold.

Next, a method for forming a film on an outer surface of a metal mold will be described.

The description below is one embodiment, and the conditions etc. are not limited thereto.

In the same manner as in the above-described centrifugal casting, a cylindrical metal mold on whose outer surface a release layer of a releasing agent is preliminarily formed so as to easily separate a formed film. The metal mold is slowly rotated so as to uniformly apply and flow-cast a coating liquid onto an entire outer surface using a dispenser, a nozzle, a spray, or the like (formation of coating film). Thereafter, rotational speed is increased to a predetermined speed, and a rotation is continued for a desired time period, while the predetermined speed is maintained at a constant rate. Then, the temperature is gradually raised while rotating the metal mold, and a solvent in the coating film is evaporated at approximately 80° C. to approximately 150° C. In this process, it is preferred that the vapor in atmosphere (evaporated solvent, etc.) be efficiently circulated and removed. When a film having self support ability is obtained, the mold is cooled to room temperature. The mold is placed in a furnace (baking furnace) which can perform high temperature treatment, and gradually heated, and finally treated (baked) at high temperature of approximately 250° C. to approximately 450° C., so as to sufficiently transform a polyimide precursor to polyimide (i.e., imidization) or a polyamideimide precursor into polyamideimide (i.e., polyamide imidization). After the imidization has been completed, the mold was gradually cooled, and a formed film is separated from the mold (demolded), to thereby produce a seamless belt.

As described above, in the case where a seamless belt (also referred to as “belt”) produced by forming a film on the inner surface of the metal mold, a surface which has been in contact with the metal mold during the production thereof becomes a front surface of the belt, and a surface which has been exposed to air during the production thereof becomes a back surface of the belt.

On the other hand, in the case where a belt produced by forming a film on the outer surface of the metal mold, a surface which has been in contact with the metal mold during the production thereof becomes a back surface of the belt, and a surface which has been exposed to air during the production thereof becomes a front surface of the belt.

The above-described method is a method for producing a seamless belt. Alternatively, the coating liquid may be applied onto a plate-shaped mold to form a sheet-shaped film, and thereafter ends of the films are joined to form a belt. In this case, a surface which has been in contact with the mold during the production thereof can be either a front surface or a back surface.

In the case of a belt produced by applying a coating liquid to a metal mold, and drying and/or curing the coating film as in the present invention, in a film forming process, particularly a drying and/or curing process, dispersibility of the carbon black is easily adversely changed. In the surface of the coating film which is in contact with the metal mold, the dispersibility of the carbon black is relatively stable, but in the surface of the coating film which is exposed to air, the dispersibility is easily changed, depending on an atmospheric temperature change, a state of humidity or solvent vapor, a state of air current, particularly, the dispersibility is significantly affected by dry conditions. The black density is high and stable when a coating liquid is dried by rising temperature with relatively long time. On the other hand, when a coating liquid is rapidly dried, the black density does not become stable, easily causing large variation among lots. These production conditions are most appropriately set, but the black density does not necessarily become stable only by setting the most appropriate conditions.

When the dispersion state of the carbon black is adversely changed in the surface of the belt which has been exposed to air during the production thereof, the surface exposed to air becomes whiter than the surface thereof which has been in contact with the metal mold during the production thereof, and the black density of the surface being exposed to air during the production thereof decreases. When the black density becomes poor, resistance value easily varies. In repetitive use, the resistance value varies, and the resistance value becomes significantly poor locally, forming abnormal images. Specifically, the black density of the surface of the belt being exposed to air during the production thereof is preferably 2.2 or more. However, it is not preferred that the black density of the surface thereof being exposed to air during the production thereof be more than 3, because a large amount of extremely fine carbon black is dispersed, causing poor mechanical strength.

The black density of the surface of the belt being exposed to air during the production thereof is preferably close to the black density of the other surface thereof being in contact with the metal mold during the production thereof. Specifically, a difference in the black density between the surface of the belt being exposed to air during the production thereof and the other surface thereof being in contact with the metal mold during the production thereof may be 0.5 or less. When the difference is large, the state of a front surface and that of a back surface of the belt are different. As a result, in repetitive use, the resistance value varies, and the resistance value becomes significantly poor locally, forming abnormal images.

Other than the method performed under the production conditions for attaining the above-described state, a method of stabilizing carbon black in a liquid to be coated is used to achieve the above-described state.

Hereinafter, a production of coating liquid preferably used in the present invention will be described.

A coating liquid used in the present invention, is produced by mixing a carbon black dispersion liquid obtained in a dispersion liquid production step with a resin and/or a resin precursor, and a solvent, so as to adjust the amount of carbon black to a certain amount (coating liquid production step).

The carbon black dispersion liquid can be obtained either by dispersing a carbon black in a solvent, or by dispersing a carbon black with a resin and/or a resin precursor in a solvent. In terms of preventing aggregation of the carbon black, the carbon black dispersion liquid obtained by dispersing a carbon black with a resin and/or a resin precursor in a solvent can be preferably used.

The dispersion of carbon black will be described with reference to an example of the case where a carbon black dispersion liquid obtained by dispersing a carbon black with a resin and/or a resin precursor in a solvent. For example, in a carbon black dispersion liquid production step, a dispersion liquid is produced by dispersing a solution, which is obtained by mixing at least a polyimide precursor solution or a polyamideimide precursor solution and carbon black in a solvent, using a disperser such as a bead mill, a ball mill, NANOMIZER, a paint shaker, a jet mill, or the like. In the carbon black dispersion liquid production step, additives such as various dispersants may be contained as necessary. Alternatively, a carbon black which has been pretreated may be used.

Hereinafter, dispersion performed with a bead mill will be described with reference to the drawings.

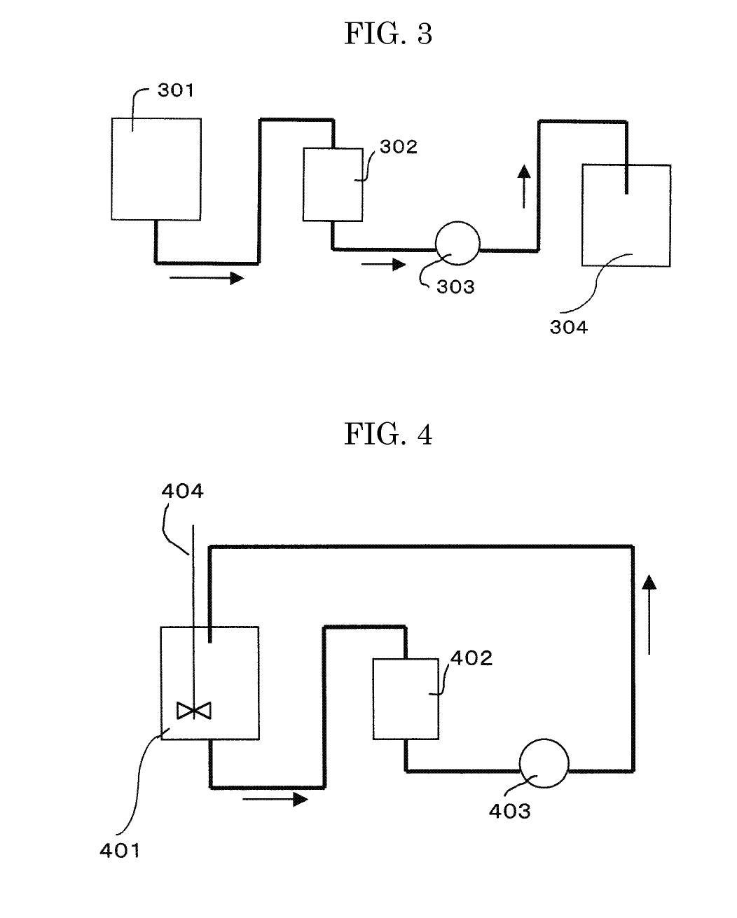

FIG. 3 is a schematic view showing an example of a disperser (bead mill disperser) of a pass system used for the production of the carbon black dispersion liquid in the dispersion liquid production step according to the present invention.

In a dispersion liquid load tank A 301, a liquid to be dispersed is loaded, and the liquid is fed to a disperser 302 by means of a liquid feeding pump 303. The disperser 302 is packed with beads having a certain size, and has a mechanism in which the beads are rotated inside thereof at high speed. The carbon black is formed into fine particles due to friction force of beads caused by rotation. The liquid containing the fine particles of the carbon black is recovered to a dispersion liquid discharge tank B 304, to thereby finish 1 pass. The dispersion force is determined depending on a rotation speed inside the disperser, a type and diameter of beads, and liquid feeding flow rate. These are adjusted to appropriate values. When the liquid recovered to the dispersion liquid discharge tank B 304 has not been sufficiently dispersed, the liquid is loaded to the dispersion liquid load tank A 301, and dispersed, again. In the pass system, this process is repeated until a dispersion liquid is sufficiently dispersed.

FIG. 4 is a schematic view showing an example of a disperser (bead mill device) of a circulation system used for the production of the carbon black dispersion liquid in the dispersion liquid production step according to the present invention.

The disperser shown in FIG. 4 is different from that shown in FIG. 3, and a liquid dispersed in a disperser 402 returns to a dispersion liquid tank A 401. The dispersion proceeds while a liquid which is not dispersed and a liquid which has been dispersed are sufficiently stirred. In this system, the dispersion is evaluated based on a state of a liquid returned from the disperser 402. Generally, the dispersion is controlled by a time required for dispersion. In FIG. 4, 403 denotes a liquid circulation pump, and 404 denotes a stirring device.

The amount of carbon black in the carbon black dispersion liquid is preferably 5% by mass to 15% by mass.

The smaller the amount of the carbon black is, the more easily the carbon black is dispersed. However, an excessively small amount of the carbon black is not efficient in the production, and becomes expensive from the standpoint of the production, thus the amount of the carbon black is preferably 5% by mass or more. When the amount of the carbon black is more than 15% by mass, dispersion efficiency severely decreases, and the dispersed carbon black particles reaggregate, which degrades stability of the dispersion liquid over time.

The solid content of the polyimide precursor or polyamideimide precursor in the carbon black dispersion liquid is preferably 5 parts by mass to 40 parts by mass relative to 100 parts by mass of the carbon black. The carbon black can be dispersed without adding the polyimide precursor or polyamideimide precursor. However, in the case where a carbon black dispersion liquid is produced without adding the polyimide precursor or polyamideimide precursor, when a dispersion liquid and a polyimide precursor solution or a polyamideimide precursor solution are mixed in a next step of adjusting the amount of the carbon black, the carbon black tends to occur shock flocculation. Then, 5 parts by mass or more of the solid content of the polyimide precursor or polyamideimide precursor is preferably added with respect to the carbon black in the carbon black dispersion liquid. When the solid content is more than 40 parts by mass, the viscosity of the solution becomes too high, causing decrease in dispersion efficiency.

Additives such as various dispersants may be appropriately added to the carbon black dispersion liquid, as necessary.

A premixing step or a multistep process of dispersion using different dispersants may be added for performing dispersion.

In the present invention, the dispersion state of the carbon black in the carbon black dispersion liquid is important. The dispersion state of the carbon black is generally indicated by particle size.

A particle size is measured with measuring instruments using a centrifugation method, laser diffraction method, dynamic light scattering method or the like. A particle size measured with a measuring instrument using the dynamic light scattering method is preferably approximately 150 nm to approximately 300 nm in volume average particle diameter. However, even though the dispersed carbon black has the particle size within the above range, intermediate transfer belts having good quality are not necessarily obtained. Particularly, quality varies among production lots, causing many defective products.

In the method for producing the intermediate transfer belt of the present invention, the carbon black dispersion liquid is applied to a substrate, and then dried so as to form a coating film, and the black density of the coating film measured with a spectrodensitometer is 2.2 or more.

Namely, in the present invention, the carbon black dispersion liquid is applied to a substrate so as to form a coating film, and then the black density of a surface of the coating film is measured. The black density of the surface of the coating film formed by applying the carbon black dispersion liquid is preferably 2.2 or more, in order to attain excellent electrical properties. In other words, the dispersion liquid having poor quality has poor black density. The better the quality becomes, the higher the black density becomes. The black density of the film surface is measured with a reflection spectrodensitometer.

The thus produced carbon black dispersion liquid is adjusted to have a certain resistance value by mixing and diluting the polyimide precursor solution or the polyamideimide precursor solution (coating liquid production step). The polyimide precursor solution or the polyamideimide precursor solution is mixed and stirred in the carbon black dispersion liquid using a commonly-used stirring device. The polyimide precursor solution or the polyamideimide precursor solution has high viscosity, thus a machine which can be adapted to high viscosity is selected. After stirring, a large amount of foam is generated in the liquid. The foam is preferably sufficiently removed by a vacuum defoaming method or the like. In the coating liquid production step, additives such as a solvent or a leveling agent can be added as necessary.

The coating liquid produced in the coating liquid production step is applied to an inner surface or an outer surface of a mold to form a coating film, and then the coating film is dried and/or cured to form a film, and then the film is demolded to thereby produce an electrophotographic intermediate transfer belt (belt production step).

By mounting the electrophotographic intermediate transfer belt of the present invention having stable electrical properties, and resistance value with less variation in an electrophotographic apparatus, even when images are repeatedly formed, the belt has high durability and formation of abnormal images (uneven image density, unprinted image portion, white spots, etc.) can be prevented, to thereby print high quality images in a stable manner.

The intermediate transfer belt (seamless belt) used in a belt constitution section of the electrophotographic apparatus (image forming apparatus) of the present invention will be specifically described hereinbelow, with reference to a schematic diagram of a main part. However, the schematic diagram is an example and the intermediate transfer belt of the present invention is not limited thereto.

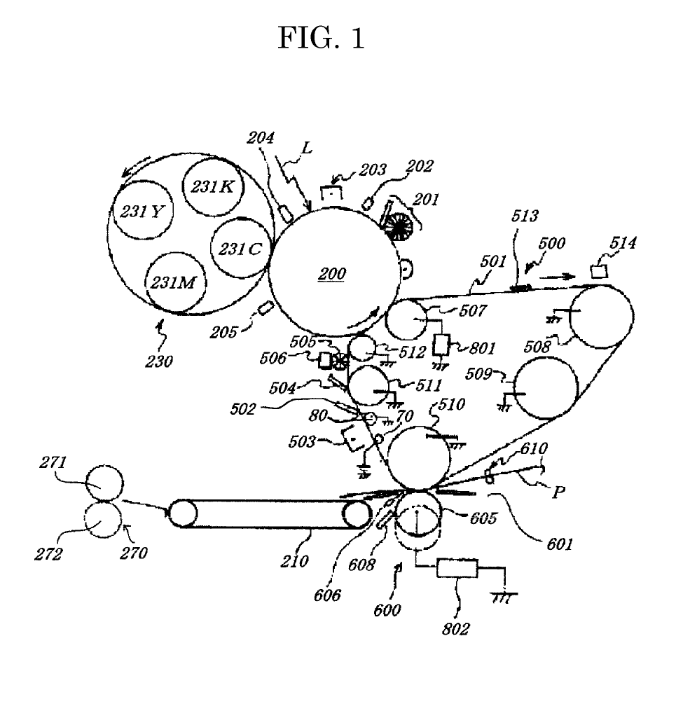

FIG. 1 is schematic diagram of a main section for explaining an intermediate transfer belt used as a belt member of an electrophotographic apparatus, and the electrophotographic apparatus using the intermediate transfer belt, according to the present invention.

As shown in FIG. 1, an intermediate transfer unit 500 including a belt member, includes an intermediate transfer belt 501 as an intermediate transfer medium stretched around a plurality of rollers. Around the intermediate transfer belt 501, a secondary transfer bias roller 605 serving as a secondary transfer charge applying unit of a secondary transfer unit 600, a belt cleaning blade 504 as a cleaning unit for the intermediate transfer medium, a lubricant applying brush 505 as a lubricant applying member of a lubricant applying unit, etc. are disposed.

A position detecting mark (not shown) is formed on an outer or inner surface of the intermediate transfer belt 501. When the position detecting mark is formed on the outer surface of the intermediate transfer belt 501, it is preferred that the mark be located at a position so as not to come into contact with the cleaning blade 504. When this structure is hard to achieve, the mark may be formed on an inner surface of the intermediate transfer belt 501. An optical sensor 514 serving as a sensor for detecting marks, is arranged at a location between a primary transfer bias roller 507 and a belt driving roller 508, which rollers support the intermediate transfer belt 501.

The intermediate transfer belt 501 is stretched around the primary transfer bias roller 507 serving as a primary transfer charge applying unit, the belt driving roller 508, a belt tension roller 509, a secondary transfer opposing roller 510, a cleaning opposing roller 511, and a feedback current detecting roller 512. Each roller is formed of a conductive material, and respective rollers other than the primary transfer bias roller 507 are grounded. A transfer bias is applied to the primary transfer bias roller 507, the transfer bias being controlled at a predetermined level of current or voltage according to the number of superimposed toner images by means of a primary transfer power source 801 controlled at a constant current or a constant voltage.

The intermediate transfer belt 501 is driven in the direction indicated by an arrow by the belt driving roller 508, which is driven to rotate in the direction indicated by an arrow by a driving motor (not shown).

The intermediate transfer belt 501 serving as the belt member is generally semiconductive or insulative, and has a single layer or a multi layer structure. In the present invention, a seamless belt is preferably used, so as to improve durability and attain excellent image formation. Moreover, the intermediate transfer belt is larger than the maximum size capable of passing paper so as to superimpose toner images formed on a photoconductor drum 200.

The secondary transfer bias roller 605 is a secondary transfer unit, which is configured to be brought into contact with a portion of the outer surface of the intermediate transfer belt 501, which is stretched around the secondary transfer opposing roller 510 by means of an attaching/detaching mechanism as an attaching/detaching unit described below. The secondary transfer bias roller 605 which is disposed so as to hold a transfer paper P with a portion of the intermediate transfer belt 501 which is stretched around the secondary transfer opposing roller 510, is applied with a transfer bias of a predetermined current by the secondary transfer power source 802 controlled at a constant current.

A pair of registration rollers 610 feeds the transfer paper P as a transfer medium at a predetermined timing in between the secondary transfer bias roller 605 and the intermediate transfer belt 501 stretched around the secondary transfer opposing roller 510. With the secondary transfer bias roller 605, a cleaning blade 608 as a cleaning unit is in contact. The cleaning blade 608 performs cleaning by removing deposition deposited on the surface of the secondary transfer bias roller 605.

In a color copying machine having the above-mentioned construction, when an image formation cycle is started, the photoconductor drum 200 is rotated by a driving motor (not shown) in a counterclockwise direction indicated by an arrow, so as to form Bk (black), C (cyan), M (magenta), and Y (yellow) toner images on the photoconductor drum 200. The intermediate transfer belt 501 is driven in the direction of the arrow by means of the belt driving roller 508. Along with the rotation of the intermediate transfer belt 501, a formed Bk-toner image, a formed C-toner image, a formed M-toner image, and a formed Y-toner image are primarily transferred by means of a transfer bias based on a voltage applied to the primary transfer bias roller 507. Finally, the images are superimposed on one another in order of Bk, C, M, and Y on the intermediate transfer belt 501, to thereby form a color image.

For example, the Bk toner image is formed as follows.

In FIG. 1, a charger 203 uniformly charges a surface of the photoconductor drum 200 to a predetermined potential with a negative charge by corona discharging. Subsequently, at a timing determined based on signals for detecting marks on the belt, by the use of an optical writing unit (not shown) raster exposure is performed based on a Bk color image signal. When the raster image is exposed, a charge proportional to an amount of light exposure is removed and a Bk latent electrostatic image is thereby formed, in an exposed portion of the photoconductor drum 200 which has been uniformly charged. Then, by coming a Bk toner charged to a negative polarity on the Bk developing roller of a Bk developing unit 231K into contact with the Bk latent electrostatic image, the Bk toner does not adhere to a portion where a charge remaining on the photoconductor drum 200, and the Bk toner adsorbs to a portion where there is no charge on the photoconductor drum 200, in other words a portion exposed to the raster light exposure, to thereby form a Bk toner image corresponding to the latent electrostatic image.

The Bk toner image formed on the photoconductor drum 200 is primarily transferred to the outer surface of the intermediate transfer belt 501 being in contact with the photoconductor drum 200, in which the intermediate transfer belt 501 and the photoconductor drum 200 are driven at an equal speed. After primary transfer, any remaining toner which has not been transferred from the photoconductor drum 200 to the intermediate transfer belt 501 is cleaned with a photoconductor cleaning unit 201 in preparation for a next image forming operation on the photoconductor drum 200. Next to the Bk image forming process, the operation of the photoconductor drum 200 then proceeds to a C image forming process, in which C image data is read with a color scanner at a predetermined timing, and a C latent electrostatic image is formed on the photoconductor drum 200 by a write operation with laser light based on the C image data.

A revolver development unit 230 is rotated after the rear edge of the Bk latent electrostatic image has passed and before the front edge of the C latent electrostatic image reaches, and the C developing unit 231C is set to a developing position, where the C latent electrostatic image is developed with C toner. From then on, development is continued over the area of the C latent electrostatic image, and at the point of time when the rear edge of the C latent electrostatic image has passed, the revolver development unit rotates in the same manner as the previous case of the Bk developing unit 231K to allow the M developing unit 231M to move to the developing position. This operation is also completed before the front edge of a Y latent electrostatic image reaches the developing position. As for M and Y image forming steps, the operations of scanning respective color image data, the formation of latent electrostatic images, and their development are the same as those of Bk and C, therefore, explanation of the steps is omitted (the operation of Y developing unit 231Y are the same as other developing units).

Bk, C, M, and Y toner images sequentially formed on the photoconductor drum 200 are sequentially registered in the same plane and primarily transferred onto the intermediate transfer belt 501. Accordingly, the toner image whose four colors at the maximum are superimposed on one another is formed on the intermediate transfer belt 501. The transfer paper P is fed from the paper feed section such as a transfer paper cassette or a manual feeder tray at the time when the image forming operation is started, and waits at the nip of the registration rollers 610.

The registration rollers 610 are driven so that the front edge of the transfer paper P along a transfer paper guide plate 601 just meets the front edge of the toner image when the front edge of the toner image on the intermediate transfer belt 501 is about to reach a secondary transfer section where the nip is formed by the secondary transfer bias roller 605 and the intermediate transfer belt 501 stretched around the secondary transfer opposing roller 510, and registration is performed between the transfer paper P and the toner image.

When the transfer paper P passes through the secondary transfer section, the four-color superimposed toner image on the intermediate transfer belt 501 is collectively transferred (secondary transfer) onto the transfer paper P by transfer bias based on the voltage applied to the secondary transfer bias roller 605 by the secondary transfer power source 802. When the transfer paper P passes through a portion facing a transfer paper discharger 606 disposed downstream of the secondary transfer section in a moving direction of a transfer paper guiding plate 601, a charge on the transfer paper sheet is removed and then the transfer paper P is separated from the transfer paper guiding plate 601 to be delivered to a fixing unit 270 via the belt transfer unit 210 which is included in the belt constitution section (see FIG. 1). Furthermore, a toner image is then fused and fixed on the transfer paper P at a nip portion between fixing rollers 271 and 272 of the fixing unit 270, and the transfer paper P is then discharged outside of a main body of the apparatus by a discharging roller (not shown) and is stacked in a copy tray (not shown) with a front side up. The fixing unit 270 may have a belt constitution section.

On the other hand, the surface of the photoconductor drum 200 after the toner images are transferred to the belt is cleaned by the photoconductor cleaning unit 201, and is uniformly discharged by a discharge lamp 202. After the toner image is secondarily transferred to the transfer paper P, the toner remaining on the outer surface of the intermediate transfer belt 501 is cleaned by the belt cleaning blade 504. The belt cleaning blade 504 is configured to be brought into contact with the outer surface of the intermediate transfer belt 501 at a predetermined timing by the cleaning member attaching/detaching mechanism not shown in the figure.

On an upstream side from the belt cleaning blade 504 with respect to the rotating direction of the intermediate transfer belt 501, a toner sealing member 502 is provided so as to be brought into contact with the outer surface of the intermediate transfer belt 501. The toner sealing member 502 is configured to receive the toner particles scraped off with the belt cleaning blade 504 during cleaning of the remaining toner, so as to prevent the toner particles from being scattered on a conveyance path of the transfer paper P. The toner sealing member 502, together with the belt cleaning blade 504, is brought into contact with the outer surface of the intermediate transfer belt 501 by the cleaning member attaching/detaching mechanism.

To the outer surface of the intermediate transfer belt 501 from which the remaining toner has been removed, a lubricant 506 is applied by scraping it with a lubricant applying brush 505. The lubricant 506 is formed of zinc stearate, etc. in a solid form, and disposed to be brought into contact with the lubricant applying brush 505. The charge remaining on the outer surface of the intermediate transfer belt 501 is removed by discharge bias applied with a belt discharging brush (not shown), which is in contact with the outer surface of the intermediate transfer belt 501. The lubricant applying brush 505 and the belt discharging brush are respectively configured to be brought into contact with the outer surface of the intermediate transfer belt 501 at a predetermined timing by means of an attaching/detaching mechanism (not shown).

If the copying operation is repeated, in order to perform an operation of the color scanner and an image formation onto the photoconductor drum 200, an operation proceeds to an image forming process of a first color (Bk) of a second sheet at a predetermined timing subsequent to an image forming process of the fourth color (Y) of the first sheet. As for the intermediate transfer belt 501, a Bk toner image of the second sheet is primarily transferred to the outer surface of the intermediate transfer belt 501 in an area of which has been cleaned by the belt cleaning blade 504 subsequent to a transfer process of the toner image of four colors on the first sheet of the transfer paper. Then, the same operations are performed for a next sheet as for the first sheet. Operations have been described in a copy mode in which full-color copies of four colors are obtained. The same operations are performed the number of corresponding times for specified colors in copy modes of three or two colors. In a monochrome-color copy mode, only the developing unit of a predetermined color in the revolver development unit 230 is put in a development active state until the copying operation is completed for the predetermined number of sheets, and the belt cleaning blade 504 is in contact with the intermediate transfer belt 501 while the copying operation is continuously performed.

In FIG. 1, L denotes an exposing unit, 70 denotes a discharge roller, 80 denotes an earth ground roller, 204 denotes an electric potential sensor, 205 denotes a toner image density sensor, 503 denotes a charging charger, and 513 denotes a toner image.

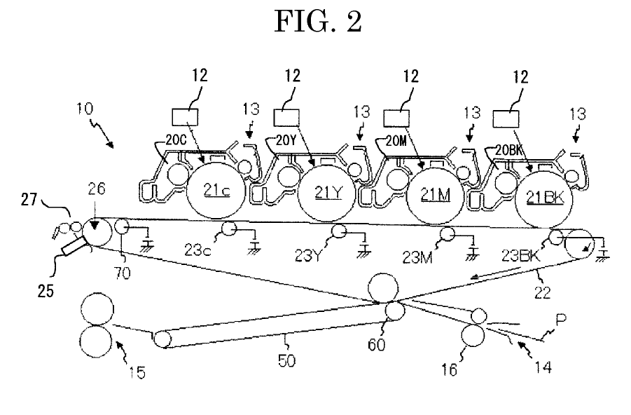

In the above-mentioned embodiment, a copier having only one photoconductor drum is described. However, the electrophotographic intermediate transfer belt of the present invention can be used, for example, in a tandem type image forming apparatus, in which a plurality of photoconductor drums are serially arranged along an intermediate transfer belt as shown in FIG. 2.

FIG. 2 shows a schematic diagram of a main part showing an example of a structure of an electrophotographic apparatus in which a plurality of photoconductor drums are serially arranged along an intermediate transfer belt provided as a belt member of the electrophotographic apparatus of the present invention. Namely, FIG. 2 shows a structural example of a four-drum digital color printer having four photoconductor drums 21Bk, 21Y, 21M, and 21C for forming toner images of four colors (black, yellow, magenta, cyan).

In FIG. 2, a main body of a printer 10 is constituted with image writing sections 12, image forming sections 13, paper feeding sections 14. Based on image signals, image processing operation is performed in an image processing section, and converted to color signals of black (Bk), magenta (M), yellow (Y), and cyan (C), and then color signals are transmitted to the image writing sections 12. The image writing sections 12 are laser scanning optical systems each including a laser light source, a deflector such as a rotary polygon mirror, a scanning imaging optical system, and mirrors, and have four optical writing paths corresponding to color signals, and perform image writing corresponding to respective color signals on image bearing members (photoconductors) 21Bk, 21M, 21Y, 21C provided for respective colors in the image forming sections 13.

The image forming sections 13 includes four photoconductors 21Bk, 21M, 21Y and 21C serving as image bearing member for Black (Bk), magenta (M), yellow (Y) and cyan (C), respectively. Generally, organic photoconductors are used as these photoconductors. Around each of the photoconductors 21Bk, 21M, 21Y, 21C, a charging unit, an exposure portion irradiated with laser beam from the image writing section 12, each of developing units 20Bk, 20M, 20Y, 20C, each of primary transfer bias rollers 23Bk, 23M, 23Y, 23C as a primary transfer unit, a cleaning unit (abbreviated), and other devices such as a discharging unit for the photoconductor (not shown) are arranged. Each of the developing units 20Bk, 20M, 20Y, 20C uses a two component magnet brush developing method. An intermediate transfer belt 22, which is the belt constitution section, is located between each of the photoconductors 21Bk, 21M, 21Y, 21C and each of the primary transfer bias rollers 23Bk, 23M, 23Y, 23C. Black (Bk), magenta (M), yellow (Y) and cyan (C) color toner images formed on the photoconductors 21Bk, 21M, 21Y, 21C are sequentially superimposingly transferred to the intermediate transfer belt 22.

The transfer paper P fed from the paper feeding section 14 is fed via a registration roller 16 and then held by a transfer conveyance belt 50 as a belt constitution section. The toner images transferred onto the intermediate transfer belt 22 are secondarily transferred (collectively transferred) to the transfer paper P by a secondary transfer bias roller 60 as a secondary transfer unit at a point in which the intermediate transfer belt 22 is brought into contact with the transfer conveyance belt 50. Thus, a color image is formed on the transfer paper P. The transfer paper P on which the color image is formed is fed to a fixing unit 15 via the transfer conveyance belt 50, and the color image is fixed on the transfer paper P by the fixing unit 15. Thereafter, the transfer paper P having a full color image is then discharged from the main body of the printer.

Toner particles remaining on the surface of the intermediate transfer belt 22, which has not been transferred in the secondary transfer process, are removed by a belt cleaning member 25. On a downstream side from the belt cleaning member 25 with respect to the rotation direction of the intermediate transfer belt 22, a lubricant applicating unit 27 is provided. 26 denotes a belt driven roller, and 70 denotes a bias roller. The lubricant applicating unit 27 includes a solid lubricant and a conductive brush configured to rub the intermediate transfer belt 22 so as to apply the solid lubricant to the surface of the intermediate transfer belt 22. The conductive brush is constantly in contact with the intermediate transfer belt 22, so as to apply the solid lubricant to the intermediate transfer belt 22. The solid lubricant is effective to improve the cleanability of the intermediate transfer belt 22, thereby preventing occurrence of filming thereon, and improving durability of the intermediate transfer belt 22.

### EXAMPLES

Hereinafter, the present invention will be specifically described based on Examples, which shall not be construed as limiting the scope of the present invention. Modification of Examples are also included within the scope of the present invention as long as they do not depart from the gist of the present invention.

### Example 1

### Production of Coating Liquid

A liquid, in which 10% by mass of a carbon black (Special black 4, manufactured by Evonik Degussa) was added to N-methyl-2-pyrrolidone (manufactured by Mitsubishi Chemical Corporation) as a solvent, was sufficiently dispersed with a bead mill (Apex Mill SAM, manufactured by KOTOBUKI INDUSTRIES CO., LTD.) using zirconia beads having a diameter of 1 mm.

Next, to this liquid, biphenyl-3,4,3′,4′-tetracarboxylic anhydride and 4,4′-diaminodiphenyl ether were each gradually added in an equimolar ratio, and polymerized at 30° C., to thereby obtain a polyamic acid coating liquid in which the carbon black was dispersed. The amounts of the biphenyl-3,4,3′,4′-tetracarboxylic anhydride and the 4,4′-diaminodiphenyl ether were adjusted, so that the amount of the carbon black in the coating liquid became 16% by mass. The particle size of the carbon black dispersed in the coating liquid was 250 nm.

### —Production of Belt—

Next, a releasing agent was applied onto an outer surface of a metal cylinder having an inner diameter of 100 mm and a length of 300 mm, so as to prepare a mold. While the cylindrical mold was rotated at 50 rpm, the coating liquid was uniformly flow-casted onto the outer surface of the cylindrical mold. At the point when a predetermined total amount of the coating liquid was flow-casted and then a coating film was uniformly formed on the outer surface of the cylindrical mold, the rotation number was increased to 100 rpm, and the mold having the coating film was placed in a circulating hot air dryer, and gradually heated up to 110° C. at 2° C./min, then heated for 60 minutes. Moreover, the mold having the coating film was heated to up to 200° C. at 2° C./min, heated at the constant temperature for 20 minutes, and the rotation was stopped, and then the mold having the coating film was gradually cooled and taken out from the dryer. Next, the mold having the coating film was placed in a heating oven (baking furnace) which could operate high temperature treatment, and was heated (baked) up to 320° C. at 3° C./min, then heated for 60 minutes. The mold having the coating film was treated for a predetermined time, and then heating was stopped. The mold having the coating film was cooled to room temperature, and then taken out from the oven. The formed thin film was separated from the outer surface of the cylindrical mold, to thereby produce a belt having a thickness of 80 μm.

### Example 2

### Production of Coating Liquid

A liquid, in which 10% by mass of a carbon black (Special black 4, manufactured by Evonik Degussa) was added to N-methyl-2-pyrrolidone (manufactured by Mitsubishi Chemical Corporation) as a solvent, was sufficiently dispersed with a bead mill (Apex Mill SAM, manufactured by KOTOBUKI INDUSTRIES CO., LTD.) using zirconia beads having a diameter of 0.3 mm. Next, to this liquid, biphenyl-3,4,3′,4′-tetracarboxylic anhydride and 4,4′-diaminodiphenyl ether were each gradually added in an equimolar ratio, and polymerized at 30° C. to thereby obtain a polyamic acid coating liquid in which the carbon black was dispersed. The amounts of the biphenyl-3,4,3′,4′-tetracarboxylic anhydride and the 4,4′-diaminodiphenyl ether were adjusted, so that the amount of the carbon black in the coating liquid became 22% by mass. The particle size of the carbon black dispersed in the coating liquid was 200 nm.

### —Production of Belt—

Next, a releasing agent was applied onto an outer surface of a metal cylinder having an inner diameter of 100 mm and a length of 300 mm, so as to prepare a mold. While the cylindrical mold was rotated at 50 rpm, the coating liquid was uniformly flow-casted onto the outer surface of the cylindrical mold. At the point when a predetermined total amount of the coating liquid was flow-casted and then a coating film was uniformly formed on the outer surface of the cylindrical mold, the rotation number was increased to 100 rpm, and the mold having the coating film was placed in a circulating hot air dryer, and gradually heated up to 110° C. at 2° C./min, then heated for 60 minutes. Moreover, the mold having the coating film was heated up to 200° C. at 2° C./min, heated at the constant temperature for 20 minutes, and the rotation was stopped, and then the mold having the coating film was gradually cooled and taken out from the dryer. Next, the mold having the coating film was placed in a heating oven (baking furnace) which could operate high temperature treatment, and was heated (baked) up to 320° C. at 3° C./min, then heated for 60 minutes. The mold having the coating film was treated for a predetermined time, and then heating was stopped. The mold having the coating film was cooled to room temperature, and then taken out from the oven. The formed thin film was separated from the outer surface of the cylindrical mold, to thereby produce a belt having a thickness of 80 μm.

### Comparative Example 1

### Production of Coating Liquid

A liquid, in which 10% by mass of a carbon black (Special black 4, manufactured by Evonik Degussa) was added to N-methyl-2-pyrrolidone (manufactured by Mitsubishi Chemical Corporation) as a solvent, was sufficiently dispersed with a bead mill (Apex Mill SAM, manufactured by KOTOBUKI INDUSTRIES CO., LTD.) using zirconia beads having a diameter of 2 mm.

Next, to this liquid, biphenyl-3,4,3′,4′-tetracarboxylic anhydride and 4,4′-diaminodiphenyl ether were each gradually added in an equimolar ratio, and polymerized at 30° C. to thereby obtain a polyamic acid coating liquid in which the carbon black was dispersed. The amounts of the biphenyl-3,4,3′,4′-tetracarboxylic anhydride and the 4,4′-diaminodiphenyl ether were adjusted, so that the amount of the carbon black in the coating liquid became 14% by mass. The particle size of the carbon black dispersed in the coating liquid was 280 nm.

### —Production of Belt—

Next, a releasing agent was applied onto an outer surface of a metal cylinder having an inner diameter of 100 mm and a length of 300 mm, so as to prepare a mold. While the cylindrical mold was rotated at 50 rpm, the coating liquid was uniformly flow-casted onto the outer surface of the cylindrical mold. At the point when a predetermined total amount of the coating liquid was flow-casted and then a coating film was uniformly formed on the outer surface of the cylindrical mold, the rotation number was increased to 100 rpm, and the mold having the coating film was placed in a circulating hot air dryer, and gradually heated up to 110° C. at 2° C./min, then heated for 60 minutes. Moreover, the mold having the coating film was heated up to 200° C. at 2° C./min, heated at the constant temperature for 20 minutes, and the rotation was stopped, and then the mold having the coating film was gradually cooled and taken out from the dryer. Next, the mold having the coating film was placed in a heating oven (baking furnace) which could operate high temperature treatment, and was heated (baked) up to 320° C. at 3° C./min, then heated for 60 minutes. The mold having the coating film was treated for a predetermined time, and then heating was stopped. The mold having the coating film was cooled to room temperature, and then taken out from the oven. The formed thin film was separated from the outer surface of the cylindrical mold, to thereby produce a belt having a thickness of 80 μm.

### Comparative Example 2

### Production of Coating Liquid

A liquid, in which 10% by mass of a carbon black (Special black 4, manufactured by Evonik Degussa) was added to N-methyl-2-pyrrolidone (manufactured by Mitsubishi Chemical Corporation) as a solvent, was sufficiently dispersed with a bead mill (Apex Mill SAM, manufactured by KOTOBUKI INDUSTRIES CO., LTD.) using zirconia beads having a diameter of 0.1 mm. Next, to this liquid, biphenyl-3,4,3′,4′-tetracarboxylic anhydride and 4,4′-diaminodiphenyl ether were each gradually added in an equimolar ratio, and polymerized at 30° C. to thereby obtain a polyamic acid coating liquid in which carbon black was dispersed. The amounts of the biphenyl-3,4,3′,4′-tetracarboxylic anhydride and the 4,4′-diaminodiphenyl ether were adjusted, so that the amount of the carbon black in the coating liquid became 26% by mass. The particle size of the carbon black dispersed in the coating liquid was 160 nm.

### —Production of Belt—

Next, a releasing agent was applied onto an outer surface of a metal cylinder having an inner diameter of 100 mm and a length of 300 mm, so as to prepare a mold. While the cylindrical mold was rotated at 50 rpm, the coating liquid was uniformly flow-casted onto the outer surface of the cylindrical mold. At the point when a predetermined total amount of the coating liquid was flow-casted and then a coating film was uniformly formed on the outer surface of the cylindrical mold, the rotation number was increased to 100 rpm, and the mold having the coating film was placed in a circulating hot air dryer, and gradually heated up to 110° C. at 2° C./min, then heated for 60 minutes. Moreover, the mold having the coating film was heated up to 200° C. at 2° C./min, heated at the constant temperature for 20 minutes, and the rotation was stopped, and then the mold having the coating film was gradually cooled and taken out from the dryer. Next, the mold having the coating film was placed in a heating oven (baking furnace) which could operate high temperature treatment, and was heated (baked) up to 320° C. at 3° C./min, then heated for 60 minutes. The mold having the coating film was treated for a predetermined time, and then heating was stopped. The mold having the coating film was cooled to room temperature, and then taken out from the oven. The formed thin film was separated from the outer surface of the cylindrical mold, to thereby produce a belt having a thickness of 80 μm.

### Comparative Example 3

A belt of Comparative Example 3 was obtained in the same manner as in Example 1, except that the belt was produced in the following manner.

### —Production of Belt—

Next, a releasing agent was applied onto an outer surface of a metal cylinder having an inner diameter of 100 mm and a length of 300 mm, so as to prepare a mold. While the cylindrical mold was rotated at 50 rpm, the coating liquid was uniformly flow-casted onto the outer surface of the cylindrical mold. At the point when a predetermined total amount of the coating liquid was flow-casted and then a coating film was uniformly formed on the outer surface of the cylindrical mold, the rotation number was increased to 100 rpm, and the mold having the coating film was placed in a circulating hot air dryer, and gradually heated up to 110° C. at 5° C./min, then heated for 60 minutes. Moreover, the mold having the coating film was heated up to 200° C. at 6° C./min, heated at the constant temperature for 20 minutes, and the rotation was stopped, and then the mold having the coating film was gradually cooled and taken out from the dryer. Next, the mold having the coating film was placed in a heating oven (baking furnace) which could operate high temperature treatment, and was heated (baked) up to 320° C. at 5° C./min, then heated for 60 minutes. The mold having the coating film was treated for a predetermined time, and then heating was stopped. The mold having the coating film was cooled to room temperature, and then taken out from the oven. The formed thin film was separated from the outer surface of the cylindrical mold, to thereby produce a belt having a thickness of 80 μm.

With respect to the belts produced in Examples 1 to 2 and Comparative Examples 1 to 3, black densities of a surface being exposed to air (also referred to as a front surface) and a surface being in contact with the mold of the belt (also referred to as a back surface) were measured with a spectrodensitometer X-rite 520 (manufactured by X-Rite).

The surface resistance values of respective belts were measured under the following conditions and variation in the surface resistance values were evaluated. The results are shown in Table 1.

### <Measurement of Surface Resistance Value>

Firstly, 500 V was applied to a belt, and after 10 seconds a surface resistance value of the belt was measured using HIRESTA (manufactured by Mitsubishi Chemical Analytech Co., Ltd.) equipped with a URS probe. With respect to each belt, surface resistance values were measured at twelve points consisting of three points in an axial direction and four points in a circumferential direction, and an average of common logarithms was determined as the surface resistance value.

### <Variation in Surface Resistance Value>

The variation in surface resistance value was evaluated in such a manner that surface resistance values in twelve points consisting of three points in an axial direction and four points in a circumferential direction of each of the belts were measured, and then a standard deviation of the common logarithms was obtained. A value of the standard deviation was preferably 0.2 or less. The standard deviation of more than 0.2 was not preferable because of large variation.

Moreover, each belt was mounted in an electrophotographic apparatus (IMAGIO MPC4500, manufactured by Ricoh Company, Ltd.) as shown in FIG. 2, and a test image was continuously printed on 10,000 sheets, and the durability of the belt was evaluated. The results are shown in Table 1.

TABLE 1

| | | | | Difference in | | | |
|---|---|---|---|---|---|---|---|
| | | | | black density | | | |
| | Amount of | Black density | Black | between front | | | |
| | carbon | of front | density of | surface and | Surface | Variation in surface | |
| | black | surface of | back surface | back surface of | resistance value | resistance value | State of image/state |
| | (% by mass) | belt | of belt | belt | (logR) | (standard deviation) | of belt |
| Ex. 1 | 16 | 2.235 | 2.612 | 0.377 | 11.0 | 0.18 | Excellent |
| Ex. 2 | 22 | 2.542 | 2.732 | 0.190 | 11.1 | 0.15 | Excellent |
| Comp. | 14 | 2.186 | 2.596 | 0.410 | 11.2 | 0.35 | Uneven density |
| Ex. 1 | | | | | | | occurred in a |
| | | | | | | | half-tone image. |
| Comp. | 26 | 3.013 | 3.102 | 0.089 | 11.1 | 0.15 | Unprinted image |
| Ex. 2 | | | | | | | portion occurred |
| | | | | | | | in part, because |
| | | | | | | | cracks occurred |
| | | | | | | | in the belt. |
| Comp. | 22 | 2.23 | 2.732 | 0.502 | 11.3 | 0.18 | Unprinted image |
| Ex. 3 | | | | | | | in a form of a |
| | | | | | | | white spot |
| | | | | | | | occurred due to |
| | | | | | | | discharge. |

As can be seen from the results of Table 1, when the black density of the front surface or the back surface of the belt was less than 2.2, the variation in surface resistance value was large, and an image having uneven density was formed. On the other hand, when the black density of the front surface or the back surface of the belt was more than 3, the amount of the carbon black to be added was large, and the mechanical strength of the belt became poor, which caused breakage or cracks in the belt. When the difference in the black density between the front surface and the back surface was more than 0.5, dot-shaped unprinted image portion (white spots) occurred due to partial discharge. Namely, in the case where a belt was formed according to the present invention, the belt having excellent state was obtained.

Next, Examples using a carbon black dispersion liquid prepared by dispersing a carbon black with a resin and/or a resin precursor in a solvent will be described.

### Examples 3 to 4 and Comparative Examples 4 to 7

### Production of Carbon Black Dispersion Liquid Nos. 1 to 4

A solution prepared by stirring a mixture having the following composition was dispersed with a disperser of a pass system shown in FIG. 3 using a bead mill (Apex Mill AM, manufactured by KOTOBUKI INDUSTRIES CO., LTD.) with zirconia beads having a diameter of 1 mm. The number of passes for obtaining carbon black dispersion liquid Nos. 1 to 4 was respectively as follows: 3 passes (the dispersion liquid No. 1), 6 passes (the dispersion liquid No. 2), 10 passes (the dispersion liquid No. 3), and 13 passes (the dispersion liquid No. 4).

### —Compositions of Carbon Black Dispersion Liquid Nos. 1 to 4—

A polyimide solution (U-Varnish A (solid content of 18% by mass), manufactured by Ube Industries, Ltd.): 11% by mass

A carbon black (Special black 4, manufactured by Evonik Degussa): 10% by mass

A solvent (N-methyl-2-pyrrolidone, manufactured by Mitsubishi Chemical Corporation): 79% by mass

### —Production of Carbon Black Dispersion Liquid Nos. 5 to 8—

Next, carbon black dispersion liquid Nos. 5 to 8 were produced in the same manner as in the carbon black dispersion liquid Nos. 1 to 4, except that the carbon black used in each of the carbon black dispersion liquid Nos. 1 to 4 was changed to a carbon black of different production lot. The number of pass for obtaining the carbon black dispersion liquid Nos. 5 to 8 was respectively as follows: 3 passes (the dispersion liquid No. 5), 6 passes (the dispersion liquid No. 6), 10 passes (the dispersion liquid No. 7), and 13 passes (the dispersion liquid No. 8).

The particle size and black density of each carbon black dispersion liquid No. 1 to 8 obtained by each number of pass thereof were measured as follows. The measurement results of the particle size and black density of each carbon black dispersion liquid are shown in Table 2.

### <Measurement of Particle Size>

The obtained carbon black dispersion liquid was diluted 200-fold with N-methyl-2-pyrrolidone, and the diluted liquid was measured with MICROTRACK UPA150EX (manufactured by NIKKISO CO., LTD.).

### <Measurement of Black Density>

Onto a PET film, the carbon black dispersion liquid was casted with an applicator, and then the PET film was dried at 100° C. for 15 minutes with a dryer, followed by cooling. A surface of the dried coating film was measured with a spectrodensitometer X-rite 520 (manufactured by X-Rite).

TABLE 2

| Dispersion | Number of | Particle size | |
|---|---|---|---|
| liquid No. | dispersion pass | (μm) | Black density |
| 1 | 3 passes | 0.400 | 0.2090 |
| 2 | 6 passes | 0.300 | 0.2150 |
| 3 | 10 passes | 0.270 | 0.2210 |
| 4 | 13 passes | 0.245 | 0.2315 |
| 5 | 3 passes | 0.300 | 0.2010 |
| 6 | 6 passes | 0.275 | 0.2130 |
| 7 | 10 passes | 0.245 | 0.2180 |
| 8 | 13 passes | 0.223 | 0.2283 |

Next, using each carbon black dispersion liquid and the following component composition, a coating liquid was produced.

### —Component Composition of Coating Liquid—

The prepared carbon black dispersion liquid: X % by mass

A polyimide solution (U-Varnish A (solid content of 18% by mass), manufactured by Ube Industries, Ltd.): Y % by mass

A leveling agent (FZ2105, manufactured by Dow Corning Toray Co., Ltd.): 0.02% by mass

The amounts (X and Y) of the carbon black dispersion liquid and the polyimide solution in the above formulations were determined, so that the resulting belt produced by using each dispersion liquid would have a surface resistance value of approximately 1×10¹¹ Ω/square. The amounts of carbon blacks in respective belts are shown in Table 3.

The correspondence relation between the dispersion liquid No. and Examples and Comparative Examples were as follows: the dispersion liquid No. 1 (Comparative Example 4), the dispersion liquid No. 2 (Comparative Example 5), the dispersion liquid No. 3 (Example 3), the dispersion liquid No. 4 (Example 4), the dispersion liquid No. 5 (Comparative Example 6), the dispersion liquid No. 6 (Comparative Example 7), the dispersion liquid No. 7 (Comparative Example 8), and the dispersion liquid No. 8 (Example 5).

### —Production of Belt—

Next, a releasing agent was applied onto an outer surface of a metal cylinder having an inner diameter of 100 mm and a length of 300 mm, so as to prepare a mold. While the cylindrical mold was rotated at 50 rpm, the coating liquid was uniformly flow-casted onto the outer surface of the cylindrical mold. At the point when a predetermined total amount of the coating liquid was flow-casted and then a coating film was uniformly formed on the outer surface of the cylindrical mold, the rotation number was increased to 100 rpm, and the mold having the coating film was placed in a circulating hot air dryer, and gradually heated up to 110° C. at 2° C./min, then heated for 60 minutes. Moreover, the mold having the coating film was heated up to 200° C. at 2° C./min, heated at the constant temperature for 20 minutes, and the rotation was stopped, and then the mold having the coating film was gradually cooled and taken out from the dryer. Next, the mold having the coating film was placed in a heating oven (baking furnace) which could operate high temperature treatment, and was heated (baked) up to 320° C. at 3° C./min, then heated for 60 minutes. The mold having the coating film was treated for a predetermined time, and then heating was stopped. The mold having the coating film was cooled to room temperature, and then taken out from the oven. The formed thin film was separated from the outer surface of the cylindrical mold, to thereby produce a belt having a thickness of 80 μm.

### Example 6

### Production of Carbon Black Dispersion Liquid No. 9

A solution prepared by stirring a mixture having the following composition was dispersed with a disperser of a pass system using a bead mill (Apex Mill AM, manufactured by KOTOBUKI INDUSTRIES CO., LTD.) with zirconia beads having a diameter of 2 mm by 15 passes, to thereby obtain a carbon black dispersion liquid.

### —Composition of Carbon Black Dispersion Liquid No. 9—

A polyamideimide solution (HR16NN (solid content of 15% by mass), manufactured by Toyobo Co., Ltd.): 15% by mass

A carbon black (MA77, manufactured by Mitsubishi Chemical Corporation): 10% by mass

A solvent (N-methyl-2-pyrrolidone, manufactured by Mitsubishi Chemical Corporation): 75% by mass

Next, using each carbon black dispersion liquid and the following component composition, a coating liquid was produced.

### —Component Composition of Coating Liquid—

The prepared carbon black dispersion liquid No. 9: 25% by mass

A polyamideimide solution (HR16NN (solid content of 15% by mass), manufactured by Toyobo Co., Ltd.): 74% by mass

A leveling agent (FZ2105, manufactured by Dow Corning Toray Co., Ltd.): 0.02% by mass

A solvent (N-methyl-2-pyrrolidone, manufactured by Mitsubishi Chemical Corporation): 0.98% by mass

### —Production of Belt—

Next, a releasing agent was applied onto an outer surface of a metal cylinder having an inner diameter of 100 mm and a length of 300 mm, so as to prepare a mold. While the cylindrical mold was rotated at 50 rpm, the coating liquid was uniformly flow-casted onto the outer surface of the cylindrical mold. At the point when a predetermined total amount of the coating liquid was flow-casted and then a coating film was uniformly formed on the outer surface of the cylindrical mold, the rotation number was increased to 100 rpm, and the mold having the coating film was placed in a circulating hot air dryer, and gradually heated up to 110° C. at 2° C./min, then heated for 60 minutes. Moreover, the mold having the coating film was heated (baked) up to 260° C. at 2° C./min, heated at the constant temperature for 30 minutes. The mold having the coating film was treated for a predetermined time, and then heating was stopped, the mold having the coating film was cooled to room temperature, and then taken out from the oven. The formed thin film was separated from the outer surface of the cylindrical mold, to thereby produce a belt having a thickness of 80 μm.

### Comparative Example 9

A belt of Comparative Example 9 was obtained in the same manner as in Example 6, except that the belt was produced in the following manner.

### —Production of Belt—

Next, a releasing agent was applied onto an outer surface of a metal cylinder having an inner diameter of 100 mm and a length of 300 mm, so as to prepare a mold. While the cylindrical mold was rotated at 50 rpm, the coating liquid was uniformly flow-casted onto the outer surface of the cylindrical mold. At the point when a predetermined total amount of the coating liquid was flow-casted and then a coating film was uniformly formed on the outer surface of the cylindrical mold, the rotation number was increased to 100 rpm, and the mold having the coating film was placed in a circulating hot air dryer, and gradually heated up to 110° C. at 5° C./min, then heated for 60 minutes. Moreover, the mold having the coating film was heated (baked) up to 260° C. at 6° C./min, heated at the constant temperature for 20 minutes. The mold having the coating film was treated for a predetermined time, and then heating was stopped, the mold having the coating film was cooled to room temperature, and then taken out from the oven. The formed thin film was separated from the outer surface of the cylindrical mold, to thereby produce a belt having a thickness of 80 μm.

With respect to the belts produced in Examples 3 to 6 and Comparative Examples 4 to 9, black densities of a surface being exposed to air (also referred to as a front surface) and a surface being in contact with the mold of the belt (also referred to as a back surface) were measured with a spectrodensitometer X-rite 520 (manufactured by X-Rite).

The surface resistance values of respective belts were measured under the following conditions and variation in the surface resistance values were evaluated. The results are shown in Table 3.

### <Measurement of Surface Resistance Value>

Firstly, 500 V was applied to a belt, and after 10 seconds a surface resistance value of the belt was measured using HIRESTA (manufactured by Mitsubishi Chemical Analytech Co., Ltd.) equipped with a URS probe.

### <Variation in Surface Resistance Value>

The variation in surface resistance value was evaluated in such a manner that surface resistance values in twelve points consisting of three points in an axial direction and four points in a circumferential direction of each of the belts were measured, and then an average and a standard deviation of the common logarithms were obtained. A value of the standard deviation was preferably 0.2 or less. The standard deviation of more than 0.2 was not preferable because of large variation. The results are shown in Table 3.

Moreover, each belt was mounted in an electrophotographic apparatus (IMAGIO MPC4500, manufactured by Ricoh Company, Ltd.) as shown in FIG. 2, and a test image was continuously printed on 10,000 sheets, and durability of the belt was evaluated.

Table 3 shows results of the amount of a carbon black to be added, the common logarithm of surface resistance values, the standard deviation of the common logarithms, and the state of belt in evaluation of durability of the belt when printing 10,000 sheets.

TABLE 3

| | | | | | | Variation in | |
|---|---|---|---|---|---|---|---|
| | | Amount | | | Difference in | surface | |
| | | of carbon | Black | Black | black density | resistance | |
| | | black | density of | density of | between front | value | |
| | Dispersion | (% by | front surface | back surface | surface and back | (standard | |
| | liquid No. | mass) | of belt | of belt | surface of belt | deviation) | State of image/state of belt |
| Comp. | 1 | 11 | 2.132 | 2.601 | 0.469 | 0.35 | Uneven density occurred |
| Ex. 4 | | | | | | | in a half-tone image. |
| Comp. | 2 | 13 | 2.187 | 2.602 | 0.415 | 0.24 | Uneven density occurred |
| Ex. 5 | | | | | | | in a half-tone image. |
| Ex. 3 | 3 | 17 | 2.276 | 2.621 | 0.345 | 0.18 | Excellent |
| Ex. 4 | 4 | 20 | 2.365 | 2.653 | 0.288 | 0.15 | Excellent |
| Comp. | 5 | 10 | 2.036 | 2.591 | 0.555 | 0.40 | Uneven density occurred |
| Ex. 6 | | | | | | | in a half-tone image. |
| | | | | | | | Unprinted image in a form |
| | | | | | | | of a white spot occurred |
| | | | | | | | due to discharge. |
| Comp. | 6 | 12 | 2.135 | 2.591 | 0.456 | 0.32 | Uneven density occurred |
| Ex. 7 | | | | | | | in a half-tone image. |
| Comp. | 7 | 14 | 2.165 | 2.596 | 0.431 | 0.22 | Uneven density occurred |
| Ex. 8 | | | | | | | in a half-tone image. |
| Ex. 5 | 8 | 17 | 2.253 | 2.601 | 0.348 | 0.17 | Excellent |
| Ex. 6 | 9 | 19 | 2.635 | 2.695 | 0.060 | 0.16 | Excellent |
| Comp. | 9 | 19 | 2.156 | 2.687 | 0.531 | 0.17 | Unprinted image in a form |
| Ex. 9 | | | | | | | of a white spot occurred |
| | | | | | | | due to discharge. |

As can be seen from the results of Table 3, in the case where carbon blacks of the same trade name but different lots were used, even the dispersion conditions and dispersion particle sizes were the same, the same quality could not be necessarily obtained. Some were resulted in poor quality.

Namely, by using the carbon black dispersion liquid which is prepared so as to obtain 2.2 or more of the black density of the dried coating film formed on a substrate, as the coating liquid, the black densities of the surface of the belt being exposed to air during the production thereof (also referred to as a front surface) can be 2.2 to 3, and the difference in the black density between the front surface of a belt and the surface thereof being in contact with the mold of the belt during the production thereof (also referred to as a back surface) can be 0.5 or less. Thus, a belt having highly uniform resistance and stable quality can be obtained. Moreover, the constitution of the present invention can be applied not only to polyimide, but also to polyamideimide.

Therefore, an intermediate transfer belt of the present invention has excellent durability and high quality. Moreover, a belt having less variation in resistance, and high quality and high durability can be obtained, despite variation in production lots of belts or production lots of materials such as those of carbon blacks.

What is claimed is:

1. An electrophotographic intermediate transfer belt obtained by applying a coating liquid to any of an inner surface and an outer surface of the mold, and then drying or curing so as to form a film, and demolding the film, comprising:
a surface having a black density of 2.2 to 3; and
the other surface having a black density which is different from that of the surface by 0.5 or less,
wherein the black density is measured by a spectrodensitometer, and the other surface has been in contact with the mold and the surface having the black density of 2.2 to 3 has been exposed to air during the production of the intermediate transfer belt, and
wherein the coating liquid comprises at least a carbon black, any of a resin and a resin precursor, and a solvent.

2. The electrophotographic intermediate transfer belt according to claim 1, wherein the carbon black is a resistance control agent.

3. The electrophotographic intermediate transfer belt according to claim 1, wherein the amount of the carbon black in the intermediate transfer belt is 15% by mass to 25% by mass.

4. The electrophotographic intermediate transfer belt according to claim 1, wherein the mold is in the shape of cylinder.

5. The electrophotographic intermediate transfer belt according to claim 1, wherein the resin precursor is any of a polyimide resin precursor and a polyamideimide resin precursor, and the resin contained in the intermediate transfer belt is any of a polyimide resin and a polyamideimide resin.

6. A method for producing an electrophotographic intermediate transfer belt, comprising:
dispersing a carbon black in a solvent, or dispersing a carbon black with any of a resin and a resin precursor in a solvent, so as to produce a carbon black dispersion liquid;
mixing the carbon black dispersion liquid with at least any of a resin and a resin precursor, and a solvent, so as to produce a coating liquid;
applying the coating liquid to an inner surface or an outer surface of a mold to form a coating film;
drying or curing the coating film so as to form a film; and
demolding the film,
wherein a black density of the coating film of the carbon black dispersion liquid is 2.2 or more, which is measured in such a manner that the carbon black dispersion liquid is applied to a substrate to form a coating film and the coating film is measured with a spectrodensitometer, and
wherein an electrophotographic intermediate transfer belt comprises:
a surface having a black density of 2.2 to 3; and
the other surface having a black density which is different from that of the surface by 0.5 or less,
wherein the black density is measured by a spectrodensitometer, and the other surface has been in contact with the mold and the surface having the black density of 2.2 to 3 has been exposed to air during the production of the intermediate transfer belt.

7. An electrophotographic apparatus comprising
an electrophotographic intermediate transfer belt obtained by applying a coating liquid to any of an inner surface and an outer surface of the mold, and then drying or curing so as to form a film, and demolding the film, which comprises:
a surface having a black density of 2.2 to 3; and
the other surface having a black density which is different from that of the surface by 0.5 or less,
wherein the black density is measured by a spectrodensitometer, and the other surface has been in contact with the mold and the surface having the black density of 2.2 to 3 has been exposed to air during the production of the intermediate transfer belt, and
wherein the coating liquid comprises at least a carbon black, any of a resin and a resin precursor, and a solvent.
